(19) United States
(12) Patent Application Publication
(10) Pub. No.: US 2002/0037766 A1
(43) Pub. Date: Mar. 28, 2002

(54) Game and method therefor

(76) Inventor: Mario V. Muniz, Santa Catarina (BR)

Correspondence Address: DORSEY & WHITNEY, 1001 PENNSYLVANIA AVE., N.W., SUITE 300 SOUTH, WASHINGTON, DC, 20004, US

(21) Appl. No.: 09/961,244

(22) Filed: Sep. 25, 2001

Related U.S. Application Data
(63) Continuation-in-part of application No. 09/541,592, filed on Apr. 3, 2000.

(51) Int. Cl. G06F 19/00

(52) U.S. Cl. 463/17; 463/42

(57) ABSTRACT

A new lottery game provides players with an expanded opportunity to win a prize based on a play. The new lottery game increases official lottery revenues by encouraging increased play of local lotteries. The new lottery game includes a system and a method for monitoring lottery results in jurisdictions other than that of the player. A player in one jurisdiction may play a local lottery game and not match the draw in that jurisdiction. However, the numbers chosen by the player may match a draw conducted in another jurisdiction. In this event, the player may win a consolation prize that may be smaller in amount that the jackpot awarded in the player's own jurisdiction. Whereas before the player would have won nothing from the player's own local lottery, the player playing the new lottery game at least wins some money. The lottery game may be twined, or coupled to a local lottery game. Plays and payments in the lottery may be received via an Internet website.

### RELATED APPLICATIONS

This application is a continuation-in-part of U.S. application Ser. No. 09/541,592 filed Apr. 3, 2000, entitled Lottery Game.

### TECHNICAL FIELD

The technical field is lottery games and similar games of chance.

### BACKGROUND

Lotteries, especially government sponsored and regulated lotteries, are very popular in the United States and in most other countries. Currently, almost 40 States sponsor or regulate lotteries and over 300 lotteries are played world-wide. In the United States, most state lotteries are run or regulated by a state lottery organization. The state lottery organization sells lottery tickets, or chances to win a prize. The money to fund the prize comes from current ticket sales. The States like lotteries because they generate much-needed income. Players like the opportunity to win the prize.

The prize is often a winner-take all jackpot (after subtracting out the State's expenses and the amount reserved by the State to meet its funding objectives). Other prizes may be lower than the jackpot, and may be based, for example, on the amount of risk the player is willing to take. The higher the risk (the longer the odds), the larger the payout. Other lotteries provide for partial payouts. For example, if the basic lottery requires matching five numbers to win the jackpot, a match of four of the five numbers may obtain a partial prize of 1/100of the jackpot.

These lotteries generally require a player to select one or more numbers from a matrix of numbers. The cost of one such play is often nominal, for example, $1. The player may be told instantly whether the number selected is a winning number. Alternatively, the player may have to wait for as long as a week until an official number selection is completed by the State lottery organization.

Many States impose severe restrictions on lotteries. A common restriction is that the player must actually be in the jurisdiction in which the lottery sale is made. Thus a player in a first jurisdiction cannot purchase a lottery ticket for another jurisdiction without physically being in that jurisdiction. Another restriction is that gambling may not be permitted using the Internet. These and other similar restrictions may cause certain players to go to extreme means in order to purchase a lottery ticket, including traveling long distances. This behavior may become more widespread as the size of the jackpot grows. In some lotteries, jackpots routinely reach $100,000,000 or more.

These restrictions, particularly the physical presence requirements, make lottery games less desirable, and may lead to a loss of lottery sales.

### SUMMARY

A new game, which may be a lottery game, a board game, or computer game, a television game, or an Internet game compares results of the game to results of similar game played elsewhere. When played as a lottery game, the game includes a system and a method for monitoring lottery results in jurisdictions other than that of the player. A basic condition for winning a prize with the new lottery is a match between numbers drawn in a lottery of a jurisdiction in which the player did not play a local lottery. A player in one jurisdiction, such as a state, province, territory or country, for example, may play a local lottery and not match a draw of the local lottery in that jurisdiction. However, the numbers chosen by the player may match a draw conducted in another jurisdiction. In this event, the new lottery game may allow the player to win a consolation prize. Such a consolation prize may be smaller in amount than the jackpot awarded by the player's own local lottery. Whereas before the player would have won nothing from the player's own local lottery, the player playing the new lottery game at least wins some money.

In an embodiment, the new lottery game is preferably twined, or coupled to a local lottery game. In this embodiment, the new lottery game is only played by a player who first plays the local lottery game. Furthermore, the new lottery game may require the player to play against only those types of lotteries that the player has played. Alternatively, the new lottery game may allow the player to choose the lottery type against which to play.

In another embodiment, the new lottery game may be played as a stand alone game. In yet another embodiment, the new lottery game may be played as a combination of a stand alone lottery game and a twined local lottery game. In yet another embodiment, the new lottery game may be played over the Internet. In still another embodiment, the concepts of the new lottery game may be included in a board game. The new lottery game may award smaller prizes for partial matching of the play and the draw.

Operation of the new lottery game, in conjunction with the local lotteries, may follow certain general rules. The new lottery game may be played only when coupled to the play of a local lottery. A play of the new lottery game may be compared to draws of lotteries that operate outside a jurisdiction in which the player played the coupled local lottery. The new lottery game may require the player to designate a type of lottery. For example, if the player plays a specific type of a local lottery, the player may be required to designate the same type of lottery for purposes of playing the new lottery game. In picking numbers, the player selects numbers according to the local lottery's matrix. Such a matrix may comprise numbers up to 99. Differences in matrix sizes between the local lotteries and the matrix of the new lottery game do not affect the operation of the new lottery game, but may impact the probability of a player's play matching a draw of a non-local lottery. The new lottery game may give prizes based on draws of all official lotteries of types 1 through 10 throughout the world, for example. The new lottery is flexible and may accommodate other lotteries, such as lotteries that include the use of bonus numbers. The new lottery game may not be operated in conjunction with any non-official or non-authorized lottery.

Rules for playing the lotto may be provided in a brochure. A reduced instruction set may be provided on a side of the play slip opposite that of the matrix. The play slip and the brochure may also be used to list common lottery types, and jurisdictions in which lottery types are available. The brochure may be provided to players by mailing, by posting on an Internet web site, or by using any other acceptable medium.

The new lottery game should increase local lottery income because more players will be attracted to the local lottery games. The new lottery game may be played without requiring a wager from the player. Thus, the only wager collected is from the local lottery. In other embodiments, the new lottery game may required a sliding wager scale, based on the odds that the player is able to achieve.

The new lottery game, or world lotteries lotto, takes advantage of winning numbers that occur in jurisdictions outside the player's current jurisdiction, or outside a jurisdiction in which the player plays a local lottery. This new lottery game concept provides an added incentive to play a local lottery game. In addition, the new lottery game concept also provides existing jurisdiction (provinces, states, countries) with increased lottery revenues.

### DESCRIPTION OF THE DRAWINGS

The detailed description will refer to the following drawings, in which like numerals refer to like elements, and wherein:

FIG. 1A illustrates a local lottery scheme;

FIG. 1B illustrates a multiple jurisdiction lottery scheme;

FIG. 2A is a block diagram of a lottery system incorporating a world lotteries lotto;

FIG. 2B is a more detailed block diagram of the world lotteries lotto;

FIG. 2C is an overall schematic of a world lotteries lotto scheme;

FIG. 3 illustrates an example play slip for use with the world lotteries lotto;

FIG. 4 illustrates a play slip for a local lottery;

FIG. 5A illustrates an alternative local lottery play slip;

FIG. 5B illustrates a draw based on the play slip of FIG. 5A;

FIG. 6A illustrates a portion of a local lottery play slip;

FIG. 6B illustrates a portion of the lottery play slip of FIG. 6A adapted to support play of the world lotteries lotto;

FIG. 7A illustrates an alternate embodiment of a play slip for use with the world lotteries lotto;

FIG. 7B is an expanded view of the play slip of FIG. 7A;

FIG. 7C illustrates an example of a local lottery play ticket;

FIG. 8 is a diagram illustrating a calendar for playing the world lotteries lotto;

FIG. 9 illustrates an alternate embodiment of a play slip for use with the world lotteries lotto;

FIG. 10 illustrates yet another alternative embodiment of a play slip for use with the world lotteries lotto;

FIG. 11 illustrates still another alternative embodiment of a play slip for use with the world lotteries lotto;

FIG. 12 is a flow diagram illustrating processes used to play the world lotteries lotto;

FIG. 13 illustrates an example of a graphical user interface that may be used with the world lotteries lotto; and

FIG. 14 illustrates an example of a board game incorporating the world lotteries lotto concept.

FIG. 15 illustrates an Internet-based lottery game.

### DETAILED DESCRIPTION

A world lotteries lotto allows players in one jurisdiction to win a consolation prize based on matching numbers from a lottery in a second or non-local jurisdiction. The world lotteries lotto may take advantage of information sharing between different lottery organizations. The world lotteries lotto may be played “on top of” or coupled to a local lottery. That is, to play the world lotteries lotto, a player may first be required to select a local lottery to play. Alternatively, the world lotteries lotto may be played as a stand alone lottery. In either event, local lotteries may participate in the world lotteries lotto. This may be necessary because the world lotteries lotto may require information from local lotteries. This information may be most efficiently gathered if all local lotteries participate in the world lotteries lotto. The information may also be gathered from non-participating lotteries. Moreover, the local lotteries may be government run or regulated, implying that the world lotteries lotto may at least be government regulated.

Lottery games such as those of the local lotteries are described in the art. An example is U.S. Pat. No. 6,017,032 to Grippo, et al., which is hereby incorporated by reference in its entirety.

Money to fund the world lotteries lotto may come from a variety of sources, including an extra charge to play the world lotteries lotto on top of a local lottery, increased local lottery sales that may occur because of the existence of the lotto, and other sources.

As stated above, participating lotteries may be run or regulated by a government or quasi-government organization. Such a lottery organization may exist within a single governmental jurisdiction, for example, a State of the United States. Other lottery organizations may cross governmental jurisdictions. An example of such a multiple jurisdiction lottery organization is a multi-state lottery organization. In the discussion that follows, reference to a lottery organization should be understood to refer to an official, or government, organization, and reference to a jurisdiction or a specific example of a jurisdiction should be understood to refer to any political entity, including a state, province, territory, or country, and in the case of a multi-jurisdiction lottery, any one of the multiple jurisdictions.

A lottery may be categorized by one or more features. As an example, a lottery may include one or more features related to a player picking one or more numbers from one or more matrices of numbers. This step of selecting numbers may be called a play or a bet. Execution of the play usually requires the player to pay a small amount of money, called a wager. The play may be executed manually by the player using a play (or number) selection mechanism. The play may also be executed by a computer that may function as a part of a lottery system. A computer-based number selection may be called a surprise selection. The play (the numbers chosen manually by the player or by the computer) is then compared to another set of random numbers that is also chosen from the one or more matrices. This later set of numbers may be called a draw. The draw may be executed by the computer that functions as part of the lottery system.

The play selection mechanism may include a play slip containing one or more play boards. Each of the play boards may be used for making a separate play. An embodiment of the play slip will be described in more detail later. The play selection mechanism may also include a processing mechanism that reads numbers marked on the play slip. The play selector mechanism may also be incorporated in a computer system using electronic play slips, for example. Such a computer system may be coupled to or may be a part of a wide area network (WAN), a local area network (LAN), a closed loop communications network, and the Internet, for example. A comparator, which may be incorporated into the computer system, compares all the plays for a given calendar period, such as a week, for example, to draws for that same time to determine a winner of the lottery.

If the play matches the draw, the player who made the play wins a prize, usually called a main prize or jackpot. The player may also win a prize, usually smaller in value than the main prize, should the play and the draw partially match.

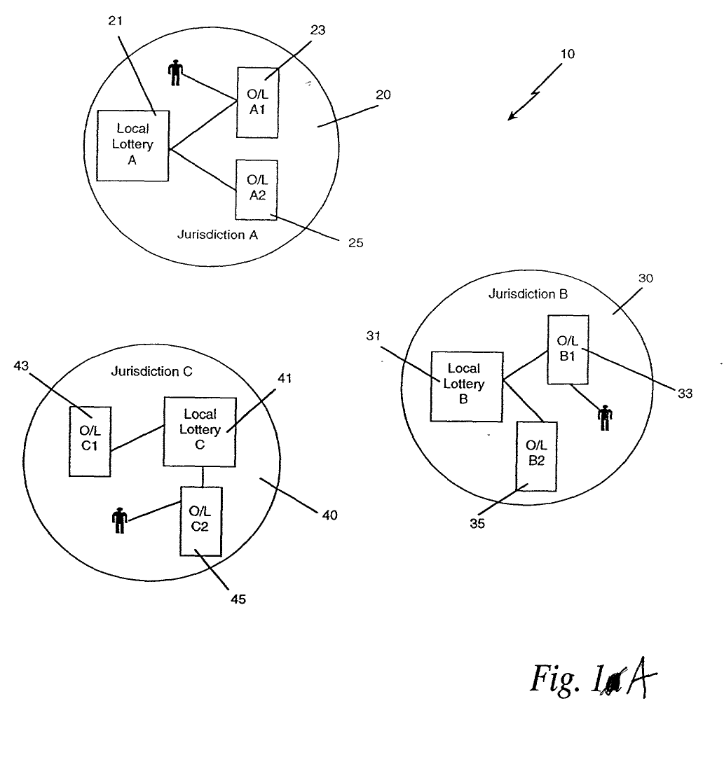

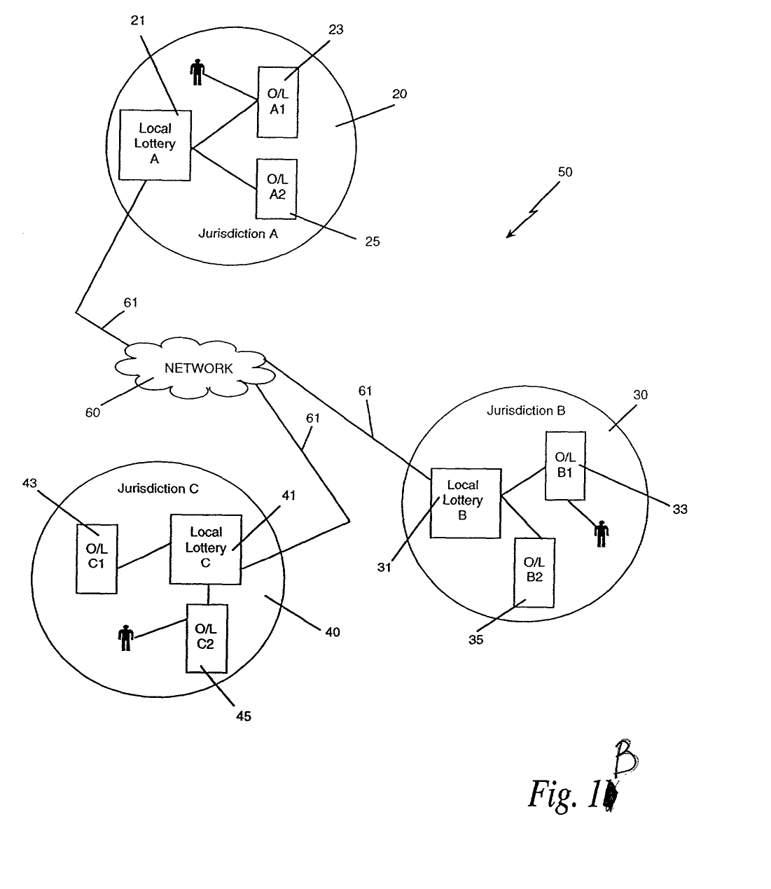

The one or more features stated above may include a first feature, the quantity of numbers to be picked when executing the play. This quantity may also be used to define a type of lottery. A lottery with a requirement to choose four numbers from a matrix may be termed a pick 4 lottery. A second feature related to the lottery may be a size of one or more of the matrices. A lottery matrix may include the numbers 1 to 49, for example. A third feature may include a second matrix and a requirement to choose one or more numbers from the second matrix. A fourth feature may be an option to pick extra numbers beyond the quantity stated in the first feature. This fourth feature may require the player to pay a higher wager for the play. A fifth feature may be a provision for bonus numbers. Many other features may be associated with a specific lottery. FIG. 1A illustrates a lottery system 10 in which a number of local jurisdictions manage or regulate a local lotteries. As shown in FIG. 1A, jurisdiction A 20 includes a local lottery A 21. The local lottery A 21 may be played by accessing a lottery outlet such as lottery outlets A1 23 and A2 25. Local lotteries are also managed or regulated in jurisdictions B 30 and C 40.

The jurisdictions shown in FIG. 1A may be States of the United States, provinces of a country, individual countries, or any other political entity. The local lotteries operating in the jurisdictions may be independent of each other, and may not share information. To play one of the local lotteries, a player may be required to be physically inside the boundaries of the appropriate jurisdiction. Thus, a player in jurisdiction A 20 cannot play the local lottery B 31, for example. The local lotteries 21, 31 and 41 may be any common lottery, such as a pick 6/49 (which means the player picks six numbers from 1 to 49) or any other lottery scheme. To win a jackpot of one of the local lotteries 21, 31 and 41, the player must select all six numbers to match numbers drawn by the local lottery. A player in jurisdiction A 20 may pick six numbers and not win the local lottery A 21. However, the same player with the same six numbers may match numbers drawn in one of the local lotteries 31 and 41. Because the player in jurisdiction A 20 did not purchase a lottery ticket in jurisdictions B 30 and C 40, the player cannot claim the jackpot in the lotteries 31 and 41, respectively, even if the players six numbers match.

FIG. 1B shows a multi-jurisdiction lottery system 50. The system 50 is similar to the system 10 shown in FIG. 1A except that the jurisdictions 20, 30, and 40 may engage in a multi-jurisdiction lottery game using, for example network 60 and communications paths 61. An example of such a multi-jurisdiction lottery is Power Ball®, which is a lottery game played among several States in the United States. A player who participates in the multi-jurisdiction lottery game, and does not match the drawn numbers, may not use a potential match with numbers drawn in another lottery outside the multiple jurisdictions 20, 30 and 40 to claim a prize.

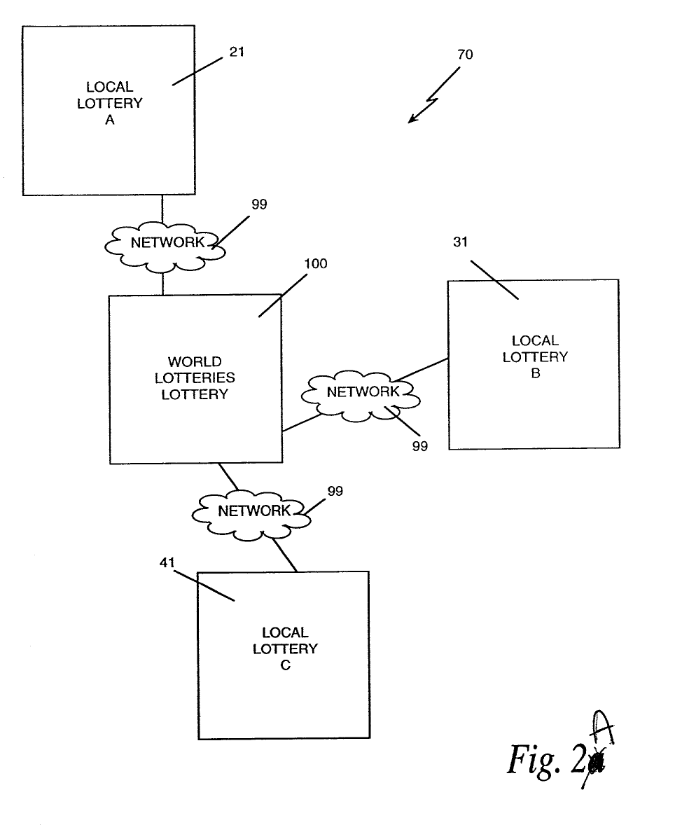

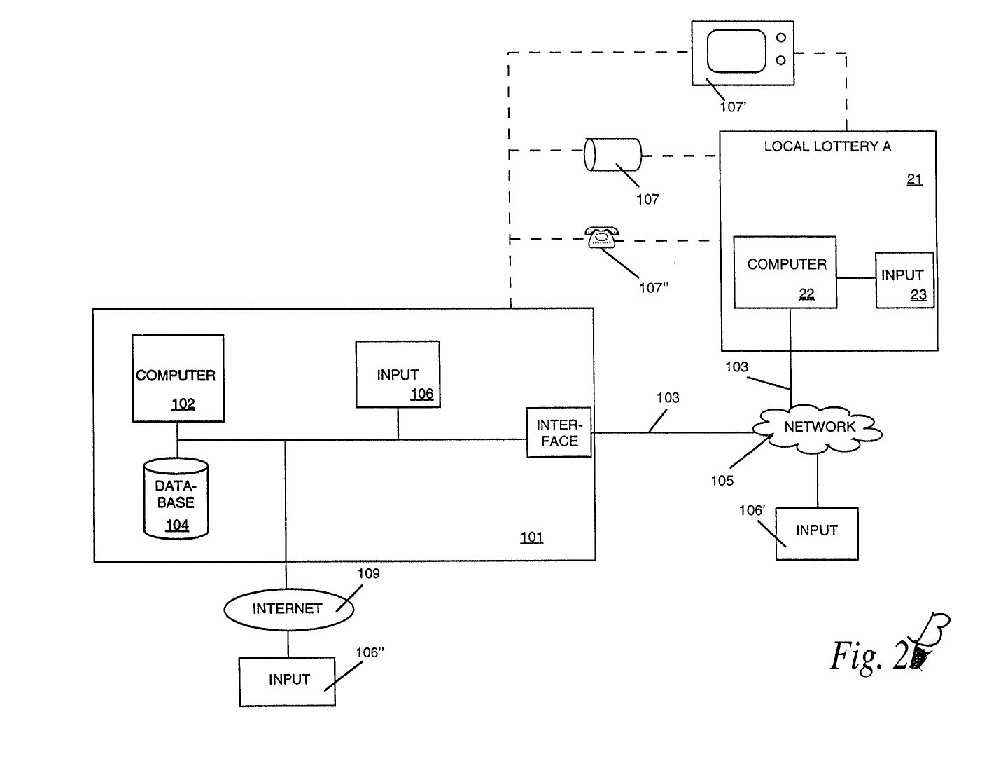

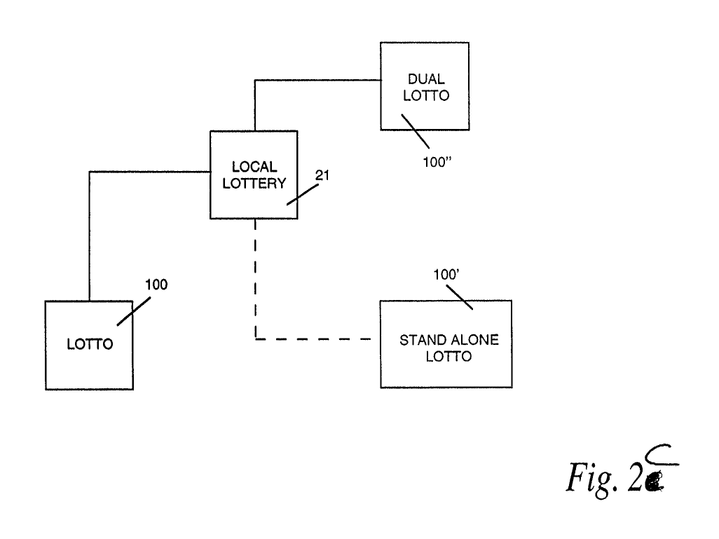

FIG. 2A is a block diagram of a world lotteries lotto system 70 that allows a player who does not match a draw in a local lottery, but does match a draw in another lottery, to win a consolation prize. The system 70 includes the local lotteries 21, 31 and 41. A player in a jurisdiction corresponding to the local lottery 21, for example, still cannot play in the local lotteries 31 and 41 without physically traveling to the jurisdictions associated with the local lotteries 31 and 41. However, a world lotteries lotto 100 may provide players in the jurisdictions 20, 30 and 40 with an opportunity to win the consolation prize should the numbers they pick in a local lottery match numbers drawn in a local lottery outside their jurisdiction. The lotto 100 may be coupled to one or more of the local lotteries 21, 31 and 41 using communications network 99. In operation, the lotto 100 may require that players in the jurisdictions 20, 30 and 40 first play one of the jurisdiction's local lotteries, such as the local lotteries 21, 31 and 41, respectively. As will be described later, the lotto 100 may also be played as a stand alone lottery.

The lotto 100 may be coupled to any number of local lotteries. For example, the lotto 100 may be coupled to all lotteries in the United States, and to all other lotteries in the world. Alternatively, the lotto 100 may be coupled to a subset of the world's lotteries.

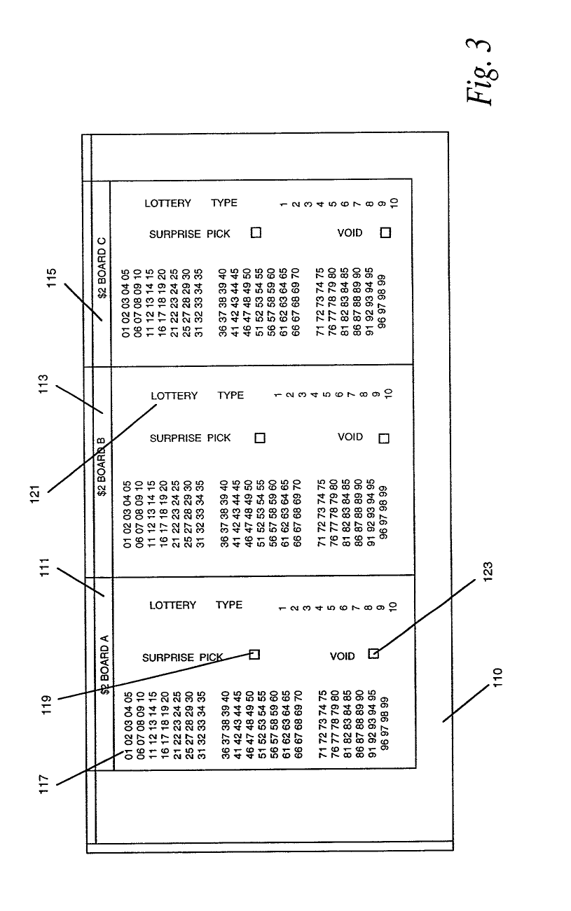

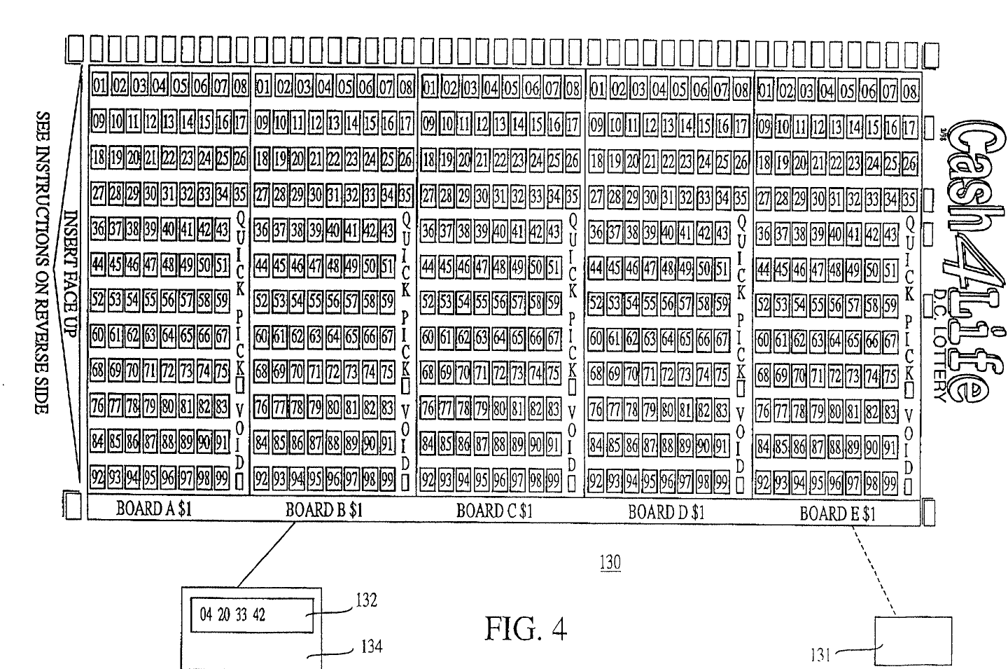

FIG. 2B is a block diagram showing various features and components of a lotto site 101 that administers the lotto 100. As shown in FIG. 2B, the lotto site 101 includes a computer 102 or similar processing device to process data and to administer the lotto 100. Coupled to the computer 102 is a database 104 that stores various information related to running the lotto 104. The database 104 may also include the algorithms and software routines necessary to process data. The database 104 may also store lotto 100 plays to compare to draws of local lotteries of other jurisdictions. An input interface 106, which may be a terminal or similar device to read a play slip, or may simply be a play slip itself, may be used by players of the lotto 100 to make wagers. As a terminal, the input 106 may be coupled to the computer 102. The input 106 is shown physically incorporated into the lotto site 101. However, the input 106 may be located remotely from the lotto site 101. In an embodiment, the input 106 may be a processing device installed at an authorized lottery retail location. Such processing devices may often be found in convenience stores, drug stores, and other similar retail stores. As noted above, the input 106 may include a device to read markings made on a lottery game play slip. Examples of lottery game play slips are shown in FIGS. 3 and 4. The input 106 may also include a processing unit and associated algorithms to determine if a play slip has been correctly filled out, to generate error messages, to record play selections, and to print out a lottery ticket. The input 106 may also include the processing capabilities to complete a random number “surprise” number selection. The surprise number selection will be described in detail later.

In addition to the input 106 being located at a retail store, an input 106′ may be available in an online version incorporating a graphical user interface. Such a graphical user interface may present an electronic version of a play slip, and may guide a player through the steps of filling out the play slip. In an embodiment, the input 106′ may be incorporated in a closed loop communications network 105 that includes the lotto site 101 and communication paths 103. In this embodiment, the input 106′ functions in much the same manner as the input 106 at the retail store. In another embodiment, an online input 106″ may be coupled to the lotto site 101 through a public communications network 109, such as the Internet. In this embodiment, the input 106″ is available to any player who can access the Internet.

The lotto site 101 is shown coupled to the local lottery A 21. In an embodiment, the local lottery A 21 and the lotto 100 may be administered by the same lottery organization and may be in the same jurisdiction. Further, the lotto site 101 and a site for administering the local lottery A 21 may be co-located. In another embodiment, the lotto 100 and the local lottery A 21 may be administered by different agencies, may be operated from different sites, and/or may be in different jurisdictions. In these embodiments, the site for the local lottery A 21 and the lotto site 101 may be connected by the closed loop communications network 105 and communications lines 103. Alternatively, the site for the local lottery A 21 and the lotto site 101 may be connected by a public communications network, such as the Internet 109.

Using the communications network 105, the lottery site 101 may receive information from the local lottery A 21, and information from other participating and non-participating lotteries. Such information may include draws, prize amounts, and other information required to play the lotto 100. This information may also be received at the site 101 by other means, including by newspaper 107, television broadcast 107′, and telephone systems 107″, for example. Players may likewise receive information related 14 to draws of non-local lotteries by using the newspaper 107, television broadcast 107′, and telephone systems 107″. The lotto site 101 periodically may publish a list of all non-local lottery draws. Such publication may be by way of the newspaper 107, for example.

FIG. 2C is an overall schematic of various world lotteries lotto options. In FIG. 2C, the lotto 100 is shown as a lottery game coupled to the local lottery A 21. A world lotteries lotto stand alone lotto 100′ may receive information from the local lottery A 21, but is not operated in conjunction with any local lottery, including the local lottery A 21, and may not be regulated by an organization regulating the local lottery A 21. A world lotteries lotto dual lotto 100″ may be coupled to one or more local lotteries, such 23 as the local lottery A 21, may be regulated by the local lottery A 21, and may share information with one or more local lotteries, such as the local lottery A 21. The lotto 100″ may be played as a twined lotto with respect to some local lotteries, and as a stand alone lottery with respect to other local lotteries.

FIG. 3 illustrates an example of a play slip for use with the lotto 100. In FIG. 3, a play slip 110 includes board A 111, board B 113 and board C 115. Each of the three boards costs a nominal amount to play. In the example shown, each of board A 111, board B 113 and board C 115 cost $2 to play. However, other amounts could be charged to play a board. In another example, a player would only pay for a play on a local lottery and would be able to play the lotto 100 for no additional charge.

A player indicates entries on the play slip 110 by marking over a particular desired number using a pencil or blue or black ink. The entries are then read by a machine capable of reading such entries.

Each of the boards 111, 113 and 115 includes a matrix 117 of numbers. In the example shown, the matrix 117 includes 99 numbers. The play slip 110 includes, for each of the boards 111, 113 and 115, a surprise number block 119. The surprise number block 119 is used when a player wants the numbers to be chosen at random by a computer or similar device. Next, the play slip 110 includes, for each of the boards 111, 113, and 115, a lottery type selection 121. The player uses the lottery type selection 121 to choose whether to play a pick 6 lottery, for example. Use of the lottery type selection 121 will be described in detail later. Finally, the play slip 110 includes, for each of the boards 111, 113 and 115, a void block 123. When a player marks the void block 123, any entries, or numbers chosen on that particular board are ignored.

FIG. 4 is an example of a local lottery play slip 130 for a local lottery 131. As will be described later, the lotto 100 may be linked or coupled to the local lottery 131. The local lottery 131 in this case is a pick 4 lottery with a matrix of 99 numbers. Such a lottery may be designated as a 4/99 lottery, meaning a player must choose four numbers from the matrix of 99 numbers. The play slip 130 allows for multiple plays. The play slip 130 also includes a surprise feature and a void block.

As illustrated in FIG. 4, a player has made a number selection 132 consisting of the numbers 04 20 33 42. The selection 132 is indicated on a ticket 133 that the player uses to claim a prize, if the selection 132 matches the numbers drawn by the local lottery 131.

In operation, the local lottery 131 may be played on a weekly basis, and may include a main lottery of cash for life. Every seven days, four numbers from 0 to 99 are drawn by the local lottery 131. An example of a draw is 05 20 63 98. A player who matches all four numbers drawn wins the top prize, in this case $1,000 each week for the life of the player, for a minimum of ten years. Thus, a winning player receives a minimum of $520,000.

The local lottery 131 includes payouts for partial matching of numbers. For example, a player who matches three out of four numbers wins $20. A player who matches two out of four numbers wins $1.

The local lottery 131 also includes three cash bonus lotteries with prizes of $100,000, $50,000, and $25,000. Each player who enters the main lottery of cash for life main lottery is automatically entered into the cash bonus lotteries. In the cash bonus lotteries, the player's numbers are chosen by a computer.

Finally, the local lottery 131 includes a consecutive draw feature that allows a player to play up to 28 consecutive lottery games (i.e., play for 28 week in advance) by requesting a multi draw ticket. The player may manually enter numbers on the multi draw ticket, using a same set of numbers or different numbers. Alternatively, the player can have the computer choose numbers to play.

Lotteries such as the local lottery 131 are common throughout the world. Of these k/N types of lotteries, a 6/49 lottery is most common. In these lotteries, the player is normally allowed to chose a maximum of k numbers. Thus, a player in a 6/49 lottery must choose exactly six numbers from a matrix of 49 numbers. Any other combination of selected numbers will result in an error, and the play will not be counted.

Returning to the example of the local lottery 131 shown in FIG. 4, the player has only one chance in about four million of winning the top prize. In the example described above, the player selects 04 20 33 42 and wins nothing. However, this same selection of numbers (i.e., 04 20 33 42) may have been drawn in one of the other several hundred lotteries played around the world during approximately the same time as the as the player made the selection 132. The player in this situation may like the opportunity to win a consolation prize based on the selection 132 matching a draw in one of these other lotteries.

To expand the player's chances of winning at least some money, the lotto 100 allows the player of a local lottery, such as the local lottery 131, to enter the number selection in the lotto 100. Then, if the number selection appears in any other similar lottery in the world, the player may be able to win a consolation prize. As noted above, a player can play the lotto 100 as a stand alone game, or coupled to a local lottery, such as the lottery 131.

In an embodiment, when the lotto is played coupled to a local lottery, the player may receive the play slip 110 shown in FIG. 3. For each play in the local lottery 131, the player could make a play in the lotto 100. For example, if the player made three plays using the play slip 130, the player could make selections using the boards 111, 113 and 115. If the player in the local lottery 131 made more than three selections in the lotto 100, the player could be provided with a second play slip 110.

The player of the local lottery 131 may have selected numbers manually or by using the surprise feature. If the player selected numbers manually, the player could then make the same number selections on the play slip 110 for the lotto 100. In the example illustrated in FIG. 4, the player selected 04 20 33 42. The player would then make this same selection on the play slip 110. Alternatively, the lotto 100 may assign these same numbers to the lotto 100 play slip.

If the surprise feature was selected by the player of the lottery 131, a computer will make the same surprise selection should the player choose to play the lotto 100. If the player used the surprise feature in the local lottery 131 and elects to play the lotto 100, then the number selection for the lotto 100 may be made automatically, using the same numbers as in the surprise selection.

Because local lotteries may have draws on different days of the week, the lotto 100 includes a provision to enter a number selection only for those lotteries that have not executed a draw during the time period (e.g., one week) available to play the lotto 100. For local lotteries that execute a draw during the time period of a specific lotto 100 game, the lotto 100 will only compare the number selection to numbers drawn during a subsequent local lotto draw. This process will be described in detail later.

The example shown in FIG. 4 is a 4/99 lottery, meaning a player chooses four numbers from 1 to 99. To play the lotto 100, the player would use the same four numbers as played in the local lottery (i.e., the four numbers played in the 4/99 lottery). Note that the matrix size does not affect the ability to play the lotto 100. In the example where a player plays a 4/N local lottery, the same player who elects to play the lotto 100 may be automatically entered in the lotto 100 to have that player's play compared to draws of all 4/N lotteries world wide, with the exception of lotteries in the player's jurisdiction. To play a pick 6 lottery (a 6/N lottery), the player would have to play a pick 6 lottery in the player's local jurisdiction. In another embodiment, the same player may play a lottery type that is not played in the player's local jurisdiction. This may be accomplished in one of at least two ways. First, the player may travel to a second jurisdiction that has the desired lottery type, play that local lottery (e.g., a 6/N lottery, and then play the lotto 100 in the second jurisdiction. A second way is to play a special, or separated, lotto 100. A separated lotto may be available for play in the player's local jurisdiction as indicated by an option, on a play slip, to play a separated lotto 100. This allows the player to play any lottery type, no matter what lottery type(s) is available in the player's local jurisdiction.

To signify the lottery type, the player selects the [6] block (in the case of a pick 6 lottery) in the lottery type field 121 (see FIG. 3). The player will be entered for all local lotteries with a required selection number of than six (e.g., all pick 6 lotteries) world wide, regardless of the matrix size. Note that if a player in a 6/49 local lottery (for example) has manually chosen (or a computer using the surprise option has chosen) as one of the four number selections, a number greater than 42 (for example), the player may not be able to win a consolation prize based on matching another jurisdiction's local lottery of the 6/42 type.

To prevent a worthless play, the lotto 100, using specific algorithms that will be described later, may analyze a play and indicate a worthless one. For example, if the player desires to play a pick 4 lottery and picks 99 as one of the four numbers, the lotto 100 will only allow the play if there is, at the time of the bet, a 4/99 local lottery game. If a 4/99 lottery game is not available, the lotto 100 will refuse the play and will provide the player an opportunity to change the play.

Some lotteries allow a player to choose, for an additional fee, extra numbers. For example, a 6/N lottery will normally require a player to choose only six numbers. However, some 6/N lotteries may allow a player to choose 15 numbers. To choose these extra numbers, the player may pay an additional amount. The lotto 100 may accommodate the selection of additional numbers, and may also impose a higher wager for such a selection. The following Table A is an example of upper limits that may be accommodated by the lotto 100 for k/N lotteries.

TABLE A

| Lottery Type | Bottom Limit | Top Limit |
|---|---|---|
| 01 | 01 | 03 |
| 02 | 02 | 05 |
| 03 | 03 | 07 |
| 04 | 04 | 10 |
| 05 | 05 | 13 |
| 06 | 06 | 15 |
| 07 | 07 | 18 |
| 08 | 08 | 20 |
| 09 | 09 | 23 |
| 10 | 10 | 25 |

Like many local lotteries, the lotto 100 may support multiple draws. For example, the lotto 100 may support draws up to 52 weeks in advance. If a player chooses multiple draws of the lotto 100, and a local lottery is limited to a number of multiple draws less than that of the lotto 100, the lotto 100 may be played in conjunction with the local lottery only up to the multiple draw limit of the local lottery. Alternatively, the lotto 100 may continue to apply a player's number selections against the local lottery.

As noted above, in an embodiment, the player chooses, using the play slip 110 of FIG. 3, what type of lottery to play. If a player chooses a pick 7 lottery (7/N), the player must exactly match a draw of a 7/N lottery somewhere in the world in order to win a consolation prize. If the player matches all six numbers of a pick 6 lottery somewhere in the world, but does not match a pick 7 lottery, the player does not win a consolation prize. In an alternative embodiment, the player may win a smaller consolation prize based on a partial or complete match of a lottery with a value of k less than 7. In this alternative embodiment, as in other embodiments, a matrix size does not affect the player's ability to play the lotto 100, but may affect the player's ability to win at the lotto 100.

The lotto 100 may be played coupled to a local lottery. That is, to play the lotto 100, the player must first play a local lottery, such as the local lottery 131 shown in FIG. 3. The player would then be eligible to win a consolation prize if the number selection used for the local lottery, and entered through the lotto 100 matches a draw of any lottery of a chosen type outside the jurisdiction of the local lottery. This keeps the lotto 100 from competing with the local lotteries, and potentially siphoning off revenue from the local lotteries.

The lotto 100 may also be played as a stand alone lottery. In an embodiment, the lotto 100 as a stand alone game may award a consolation prize to a player for any matches outside the jurisdiction in which the lotto 100 is played. In an alternative embodiment, the lotto 100 as a stand alone lottery may award a consolation prize for any matches, including matching a numbers draw in a local lottery in the player's jurisdiction.

The lotto 100 may be played in at least two manners. In a first manner, the lotto 100 receives plays, and compares the plays to draws from lotteries outside a jurisdiction of a local lottery to which the lotto 100 is coupled. A consolation prize may be awarded for any matches. The lotto 100 may also incorporate a separate draw, and may pay a prize if the draw matches any plays. Draws of the lotto 100 may be based on the following Table B.

TABLE B

| Lottery Type | Matrix | Example |
|---|---|---|
| 1 | 9 | 1/9 |
| 2 | 13 | 2/13 |
| 3 | 21 | 3/21 |
| 4 | 30 | 4/30 |
| 5 | 35 | 5/35 |
| 6 | 49 | 6/49 |
| 7 | 50 | 7/50 |
| 8 | 51 | 8/51 |
| 9 | 54 | 9/54 |
| 10 | 60 | 10/60 |

The lotto 100 may award a consolation prize based on a match between numbers played with the lotto 100 and any numbers draw with a local lottery outside the player's jurisdiction. The consolation prize may be awarded even if no winners exist in such local lotteries. That is, even if no winner exists for any local lottery throughout the world, the player of the lotto 100 may still win a consolation prize.

If multiple winners of the lotto 100 exist, any consolation prize may be split among such multiple winners. In an embodiment, the lotto 100 may exist as a multi-jurisdiction lottery with a single consolation prize that is split among all winners from the multiple jurisdictions. In another embodiment, each jurisdiction maintains its own version of the lotto 100, and a consolation prize exists for each such jurisdiction. In this embodiment, the consolation prize is split among all winners within a jurisdiction. In yet another embodiment, the lotto 100 is permitted in some jurisdictions and not in others. The participating jurisdictions may have a common, or pooled, consolation prize. Alternatively, the participating jurisdictions may have individual consolation prizes.

In an embodiment in which less than all jurisdictions participate in the lotto 100, the lotto 100 may still award a consolation prize for matching a draw in a non-participating lottery. Alternatively, the consolation prize may be awarded based on matches between a number set played with the lotto 100 and a matching draw in a participating lottery.

Operation of the lotto 100 in conjunction with the k/N lotteries described above may follow certain general rules. For example, the lotto 100 may be played only when coupled to the play of a local lottery. Next, a play of the lotto 100 may be compared only to draws of lotteries that operate outside a jurisdiction in which the player played the coupled local lottery. The lotto 100 may require the player to designate a type of lottery. For example, if the player plays a 6/N lottery, the player may be required to designate a 6/N lottery for purposes of playing the lotto 100. In an embodiment, the lotto 100 system may automatically designate play of the lotto 100 based on a play of a coupled local lottery. That is, if the player plays a 6/N local lottery and signals a desire to play the lotto 100, the computer 102 or input 106 (see FIG. 2B), for example, may automatically require the player to use the same six numbers. Differences in matrix sizes between the local lottery and the 1 to 99 matrix of the lotto 100 do not affect the operation of the lotto 100, but may impact the probability of a player's play matching a draw of the lotto 100. Therefore, the lotto 100 gives prizes based on draws of all official lotteries of types 1 through 10. The lotto 100 may not be operated in conjunction with any non-official or non-authorized lottery. In an embodiment, the lotto 100 may not be operated using a publicly accessible network, such as the Internet.

Rules for playing the lotto 100 may be provided in a brochure. A reduced instruction set may be provided on a side of the play slip opposite that of the matrix. The play slip and the brochure may also be used to list common lottery types, and jurisdictions in which lottery types are available. The brochure may be provided to players by mailing, by posting on an Internet web site, or by using any other acceptable medium.

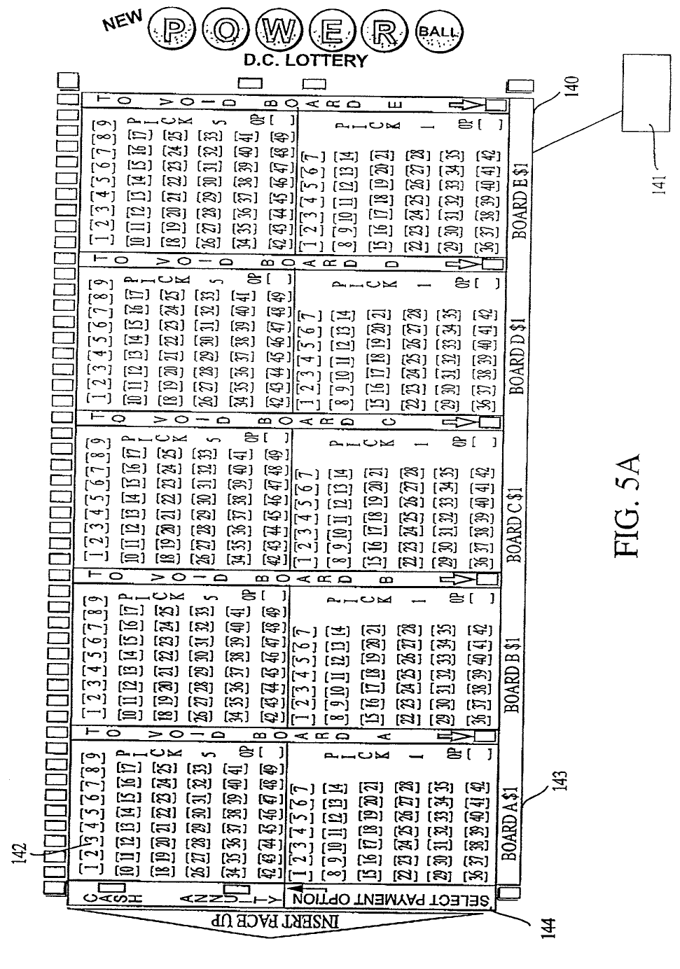

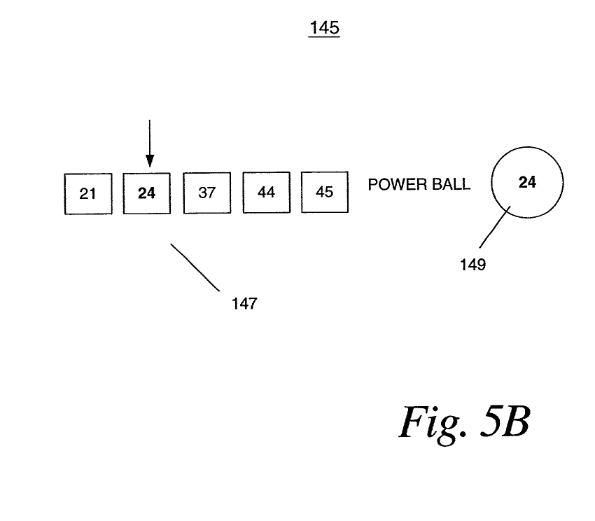

The examples of local lotteries described above have all been of the k/N format. However, many local lotteries employ other formats. FIG. 5A illustrates an example of a play slip 140 used with an a/X+b/Y lottery 141. In this example, the lottery 141, known as Power Ball®, is a multi-jurisdiction lottery game. In particular, several States of the United States, and the District of Columbia participate in and regulate the lottery game 141. The lottery game 141 is also an example of a lottery game having a main prize, or jackpot, that increases as more players make bets. Play of a particular Power Ball® game continues until a player matches a draw. Thus, a particular Power Ball® game could continue for several weeks or months, and the resulting jackpot could be enormous, $100 million or more.

The lottery 141 differs from k/N lotteries in that the player is required to choose (manually or using surprise) five numbers from a 49 number matrix section 142 of the play slip 140. The player is also required to choose one number from a 42 number matrix section 144 of the play slip 140. The format of the lottery 141 is thus 5/49+1/42. As with other lotteries, the play slip 140 allows for multiple plays, using one or more of the boards 143. The odds of winning are about 1 in 80 million.

Because some of the numbers repeat between section 142 and 144, a player may win a game of the lottery 141 repeating one number. An example of this situation is shown in FIG. 5B. A draw 145 includes a set 147 of five numbers, 21 24 37 44 and 45. A power ball set 149 shows the number 24 drawn from the 42 number matrix. Thus, the drawn number 24 appears in both sets of drawn numbers, sets 147 and 149. In other words, the lottery 141 draw includes only five unique numbers. The implications of such a draw on the lotto 100 will now be explained. For the lotto 100, a player in a jurisdiction outside the jurisdictions of the lottery 141, may win the consolation prize of the lotto 100 if the player chooses five numbers that match the five unique numbers drawn in the lottery 141. Thus, if a player of the lotto 100 chooses to play a 6/N lottery, the player can win a consolation prize based on a draw of the lottery 141 if such player selects five matching numbers and one number of the draw in the lottery 141 repeats.

Another example of a lottery game that does not follow the exact format of a k/N lottery is an a/X+m lottery, such as the 6/45+2 bonus Australian lottery. Such a lottery requires the player to pick six numbers from a 45 number matrix. A computer associated with the lottery then draws six main numbers and two bonus numbers. The player whose six selected numbers matches any of the six main wins the lottery. A player who matches six of the eight drawn number may win a smaller prize. The lotto 100 may accommodate such a/X+m lotteries. In an embodiment, a player of an a/X+m lottery may win the lotto 100 consolation prize by matching six numbers in any non-local 6/N lottery worldwide. That is, the lotto 100 may ignore any bonus numbers selected in an a/X+m lottery. Thus, in the example of the Australian lottery, only the pick six numbers from the 45 number matrix are used to determine a winner of the consolation prize of the lotto 100.

In another embodiment, the lotto 100 will combine all a+m numbers to determine a winner of the consolation prize. In the Australian lottery example, the six numbers chosen by a player will be used along with the two drawn bonus numbers. The player of the lotto 100 then selects a pick 6 lottery, the lotto 100 will compare all eight numbers to any six numbers drawn in other local lotteries of the 6/N format to determine a winner of the consolation prize.

In yet another embodiment, the lotto 100 will combine all a+m numbers selected to determine the type of lottery for comparison. In this embodiment, the player would mark a [a+m] block on the lotto 100 play slip to indicate this type of lottery. In the

Australian lottery example, the lotto 100 would compare the eight numbers (six selected, two drawn bonus numbers) with any draws in an 8/N local lottery.

In yet another type of local lottery, a player may a selection of a specific quantity of numbers and the lottery system draws two sets of numbers. An example of such a lottery is the Brazilian Super Sena lottery that draws two series of six numbers each. The format of such a lottery may be expressed as a/X+p(a/X), where p is an integer greater than zero. The lotto 100 may treat such a local lottery as p separate a/X lotteries. A player of the lotto 100 may match either of the draws to win the consolation prize. Thus the player of the a/X+p(a/X) may have as many as 1+p times as many chances of winning the lotto 100.

As noted above, in an embodiment, the lotto 100 is played in conjunction with playing a local lottery. This requirement should encourage more play of local lotteries because of the possibility of a consolation prize. The lotto 100 could be operated in a single jurisdiction, with the winning play based on lottery results within other jurisdictions. For multiple jurisdiction games (e.g., Power Ball®)), all lotteries within the multiple jurisdiction could be used to determine a winner of the lotto 100. Alternatively, the lotto 100 could be operated as a single multiple jurisdiction lottery, such as a national lottery within the United States. In this alternative, lottery results from all local lotteries in the United States could be used to determine a winner of the lotto 100. In all these alternatives, a player may first be required to play a local lottery before becoming eligible to play the lotto 100.

In another embodiment, the lotto 100 may be played as a stand alone lottery. Such a stand alone lottery may use lottery results from one or more jurisdictions to determine a winner of the lotto 100. In this embodiment, the player may fill out as many play slips as desired. Play slips may be completed for all types of lotteries, not just for local lottery types within the player's jurisdiction.

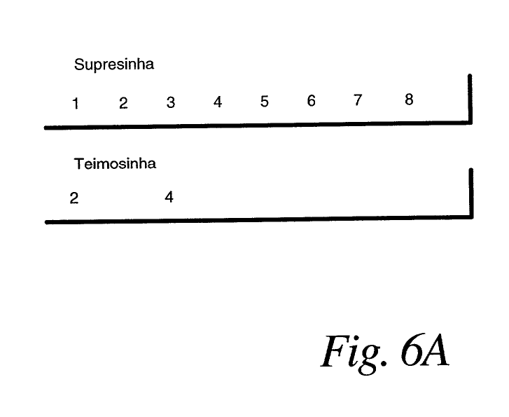

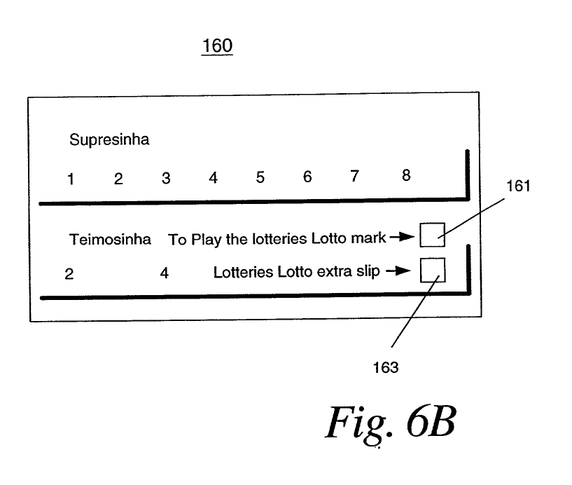

As mentioned above, the lotto may be played in conjunction with a local lottery, such as the local lottery. In an embodiment, a player of a local lottery is automatically entered into the lotto, using the type of local lottery played and the lottery type for lotto 100 purposes. For example, a player of the local lottery 131 shown in FIG. 3 would be automatically entered in the lotto 100, and the player's number selection would be compared to draws of all type 4 local lotteries. In this embodiment, the player may not be charged an additional fee for playing the lotto 100, and all funds needed to support the consolation prize may be derived from increased local lottery sales. In another embodiment, the player may indicate on a local lottery play slip, a desire to play the lotto 100. FIG. 6A shows a portion 150 of a Brazilian Super Sena lottery play slip. The portion 150 shown provides the player with the option of choosing to play the lotto 100 with a twined local lottery.

FIG. 6B shows a modified section 160 of the play slip of FIG. 6A. The section 160 now includes a block 161 that may be marked by a player to indicate a desire to play the lotto 100. Such a play may require payment of an additional wager. Also shown is a block 163 that may be marked to indicate a desire for an additional lotto 100 play slip. Such an additional play slip may be used when a player has played a local lottery with more boards than are provided on the lotto 100 play slip 110 shown in FIG. 3, for example.

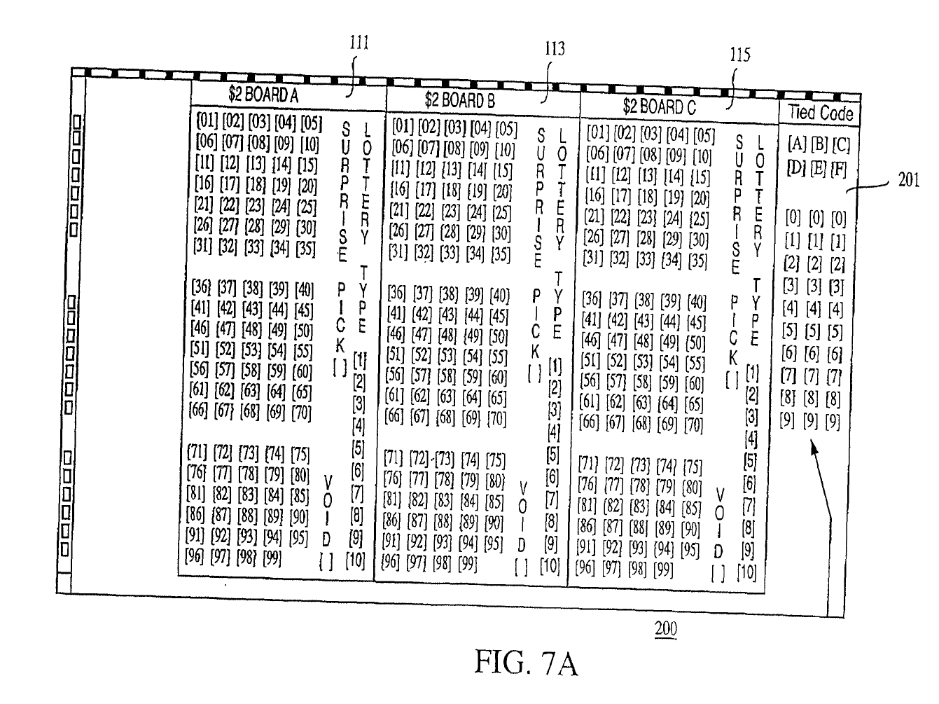

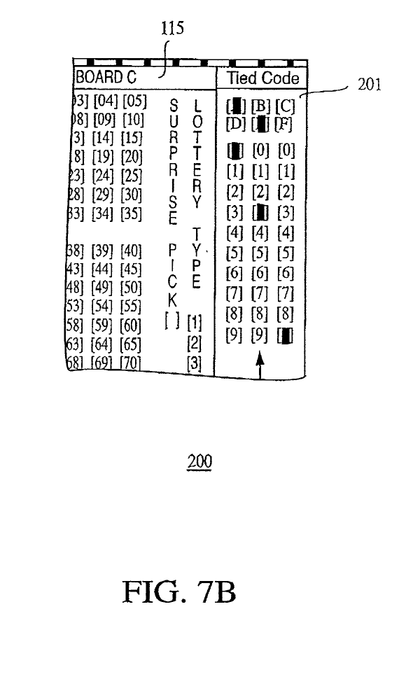

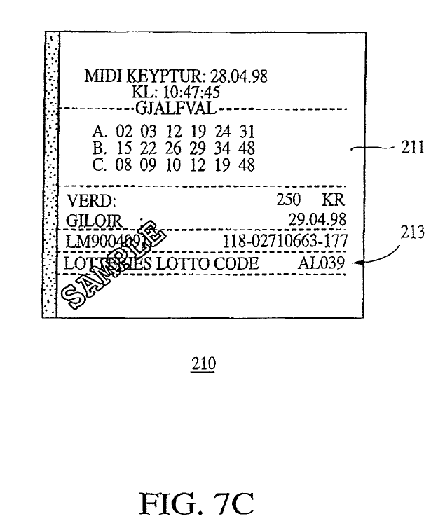

FIG. 7A illustrates a play slip 200 that may be used with the lotto 100. The play slip 200 is similar to the play slip 110 shown in FIG. 3. However, the play slip 200 includes an additional section 201 that may be used to tie or couple the lotto 100 to a local lottery, such as the local lottery 131 shown in FIG. 4. The section 201 includes a place to record a special code generated by the lotto 100. In particular, either the input 106 or the computer 102, or a similar device, may generate an alpha-numeric code that may be manually marked on the play slip 200. The code may be generated whenever the block 163, shown in FIG. 6B is marked. The special code gives the player one, and only one, special play slip. The special code may be a set of 30 numbers and six letters, for example. The special code is generated with a cryptography that combines the type of lottery, the number of the draw, and a local lottery identifier, for example.

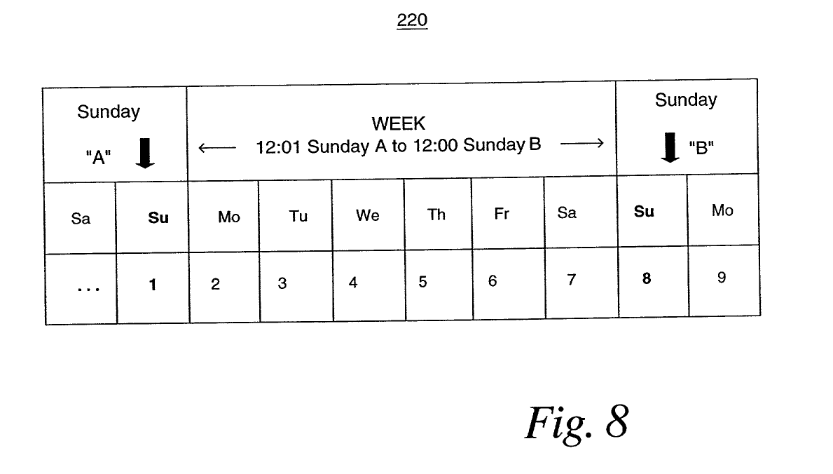

FIG. 7B shows a portion of the play slip 200 with the section 201 marked with a special code. The special code, in the example, AE039, is used to tie the local lottery to the lotto 100. The special code is also printed on a lotto ticket. An example lotto ticket 210 is shown in FIG. 7C. The lotto ticket 210 includes a printout of numbers played 211 and the special code 213. The lotto 100 may be set to begin on any day, and to run for a week, for example. In an embodiment, the lotto 100 begins on Sunday at 12:00 p.m. (one minute past noon) Greenwich Mean Time (GMT) and end the following Sunday at noon. The lotto 100 may accept plays from 12:01 p.m. GMT on Sunday until noon the following Sunday. FIG. 8 shows a lotto 100 calendar 220. The starting day is Sunday A, and the ending day is Sunday B. During a week of the lotto 100, a lotto 100 player will be eligible for all draws that occur between 12:01 p.m. of Sunday B and noon of Sunday C (the Sunday following Sunday B (not shown)) for any participating local lottery. The computer 102 (see FIG. 2B) will check the winning tickets after 8 p.m. GMT of the C Sunday. Winning tickets may be announced using standard mechanism, including e-mail direct to the winner, the Internet, television and radio announcement, and publication, such as in a newspaper.

Plays received until noon (GMT) on Sunday A will be eligible for world lottery draws that occur between 12:01 p.m. (GMT) of Sunday A, and noon of Sunday B. If a player plays a local lottery and marks only the lotteries lotto block 161, the player will be eligible for lotteries operated during the following week.

Minimum prizes may be decided and funded locally. Alternatively, minimum prizes may be determined among several participating lotteries or among all participating lotteries. The basic condition for winning the lotto 100 consolation prize is to match numbers drawn in a jurisdiction in which the player did not play the local lottery. If a same combination of numbers chosen by the player is drawn in more than one local lottery, the player may receive multiple consolation prizes, one for each such match. Alternatively, the lotto 100 may be operated such that the player receives only one consolation prize. If more than one player's play matches a draw in a non-local lottery, then the players' may share the consolation prize equally. For each type of local lottery, if no match occurs using the lotto 100, any prize may roll over to the next week. In an embodiment, if the consolation prize is not awarded after a specific period, the consolation prize may be divided among those who match the most numbers.

Worldwide local lottery draw information may be collected by the lotto 100 at the lotto site 101, and stored in the database 102, for example. The draw information may be collected by telephone, facsimile, over the Internet, by television and radio, and by publication, such as in newspapers.

As discussed above, the world lotteries lotto may be played as a tied lotto 100 played in conjunction with one or more local lotteries. The world lotteries lotto may also be played as a stand alone lotto 100′. Finally, the world lotteries lotto may be played as a combination of a twined and stand alone lottery 100″ (see FIG. 2C).

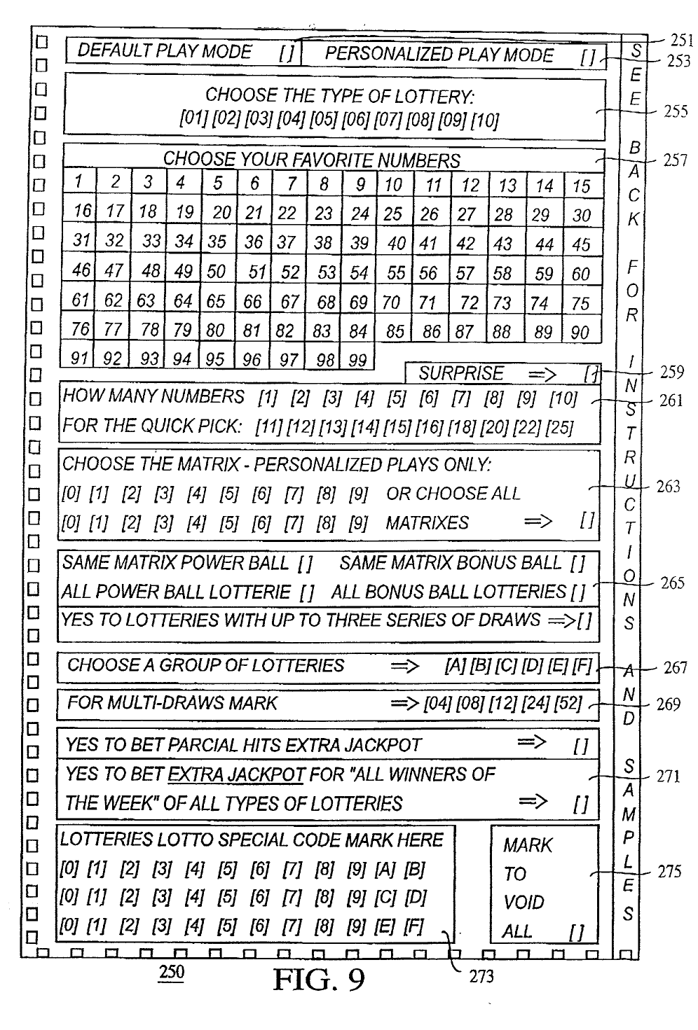

FIG. 9 shows an example of a play slip 250 that may be used for any configuration of the world lotteries lotto. The play slip 250 incorporates several features that allow a player to customize lottery play. A default play mode section 251 and a personalized play mode section 253 may be used to chose a mode of play. Alternatively, the play slip 250 may include only the personalized play mode section 253. The default mode allows the player to specify the type of lottery, the numbers to play, and whether a multi-draw option is to be used. If the personalized play mode is selected, the player will have additional options as described below.

A lottery type section 255 allows the player to choose the type of lottery to play against. For example, the player could mark the [06] in section 255 to indicate a pick 6 lottery type. The play would then be compared to draws of all participating pick 6 lotteries worldwide.

The play slip 250 includes a 99 number matrix section 257 that allows the player to choose numbers manually, and a surprise section 259 that allows a computer to pick the numbers. Associated with the surprise section 259 is a surprise number section 261. The section 261 may be used to instruct the computer to select the specified quantity of random numbers. If the section 261 is not used, the computer will select a quantity of random numbers equal to the lottery type indicated in the section 255.

A choose matrix section 263 may be used in the personalized play mode to select a size of the matrix from 9 to 99 or to choose all matrix sizes. A lottery game variation section 265 may be used to select plays in only power ball or bonus ball lotteries that have a same matrix as that selected in the choose matrix section 263. For example, a 5/49+1/42 Power Balls matrix would convert to a matrix of 49 numbers. If in the choose matrix section 263, the player chooses all matrices, the player has two selection options for the section 265, namely choosing no Power Ball® and no bonus ball lotteries or choosing all Power Ball® and all bonus ball lotteries. The section 265 also allows the player to designate lotteries with up to three series of draws. This selection would apply to lotteries with multiple draws, such as the Brazilian Super Sena lottery. Selecting this option means that all the drawn numbers in the multi-draw lottery are combined. A play will be compared to the combined numbers to determine a match. For example, if the player selects six numbers, and the three series of draws features is selected, the six numbers selected by the player (the play) are compared to all the numbers in the multiple draws. Any six numbers from the multiple draws may be used to match the numbers in the play. In an embodiment, players who elect the three series of draws feature may be eligible for a prize separate from a main consolation prize. Such election may be signaled by checking a box on the lotto 100 play slip.

A group of lotteries section 267 is used to select a mix of lotteries from different regions of the world. Information on these different regions and lotteries may be presented on a reverse side of the play slip 250. Alternatively, this information may be presented in a separate brochure, may be available electronically at an input, such as the inputs 106, 106′ and 106″ shown in FIG. 2B. Using the section 267, the player may select all lotteries from one or more of five regions of the world by selecting one or more of blocks [A]−[E]. The player may also elect to play all lotteries by selecting block [F] in section 267.

A multiple draw section 269 may be used to designate multiple draws by marking appropriate blocks for 4, 8, 12, 34 and 52 weeks.

A jackpot section 271 may be used to elect a partial match jackpot. Eligibility for this partial jackpot may be determined with reference to Table C below, or a similar scheme. The value of the partial jackpot may be determined by the amount wagered by all lotto 100 players. The jackpot section may also be used to designate an extra jackpot. The extra jackpot designation means that the player contends for a single jackpot among all types of lotteries. Choosing any of the above described jackpot options may require an increased wager to play the lotto 100.

When the world lotteries lotto is played in conjunction with one or more local lotteries, the special lotteries lotto code will be provided to the player. The code may be marked in a special code section 273. Finally, the play slip 250 includes a section 275 to void the play slip 250. Once the player has completed the play slip 250, the wager amount for the lotto 100 is determined. This determination may be made by the computer 102 or one of the inputs 106, 106′ and 106″ shown in FIG. 2B, for example. The wager amount may be determined by a number of factors, including selection of extra numbers (e.g., picking 15 numbers to play pick 6 lotteries), a number of draws per week of a local lottery, advanced plays, use of the all matrices feature (see section 263 in FIG. 9), a type of lottery (i.e., the most common lottery, a pick 6 lottery may cost more to play than a less common type lottery), jackpot selection options, use of bonus ball and similar features, regional play, and other features as illustrated by the play slip 250 of FIG. 9. However, the total extra wager cost may not vary significantly from the cost of playing a local lottery. Thus, the lotto 100 may cost $1.00 to play, and the local lottery may cost $2.00 to play, for a total wager of $3.00.

In an alternative embodiment, no extra wager is charged to play the lotto 100. However, the stand alone lotto 100′ may always require payment of a wager. When no extra wager is required to play the lotto 100, the revenues required to fund the consolation prize, any smaller prizes or other jackpots, and to pay for the administration of the lotto 100, may be generated by increased play of a local lottery brought on by the availability of the lotto 100. The split of these revenues may follow that of a typical local lottery.

The lotto 100 may include a mechanism to prevent a player from trying to buy all possible combinations and thus ensure award of a prize. One such mechanism is to make the price for such plays too high with respect to the prize to be awarded.

As noted above, the lotto 100, including all variations, may provide a prize for a partial match between the play and the draw of one or more local lotteries. Table C below illustrates one scheme for awarding the prize for a partial match. A “Y” in a cell of Table C indicates when the prize for the partial match may be available.

TABLE C

| Lottery | Number of Matches | | | | | | | | | |
|---|---|---|---|---|---|---|---|---|---|---|
| Type | 01 | 02 | 03 | 04 | 05 | 06 | 07 | 08 | 09 | 10 |
| 01 | | | | | | | | | | |
| 02 | Y | | | | | | | | | |
| 03 | | Y | | | | | | | | |
| 04 | | Y | Y | | | | | | | |
| 05 | | | Y | Y | | | | | | |
| 06 | | | Y | Y | Y | | | | | |
| 07 | | | Y | Y | Y | Y | | | | |
| 08 | | | | Y | Y | Y | Y | | | |
| 09 | | | | Y | Y | Y | Y | Y | | |
| 10 | | | | | Y | Y | Y | Y | Y | |

The value of the prize for a partial match can be determined by the local lottery organization. In addition, multiple prizes may be given for partial matches, with the value of each such multiple prize decreasing as a number of matches decreases.

A player who wins a main prize or jackpot of a local lottery may also be eligible for winning the consolation prize, if the play matches a draw in another jurisdiction. The lotto 100 may also conduct a separate draw to award a separate jackpot.

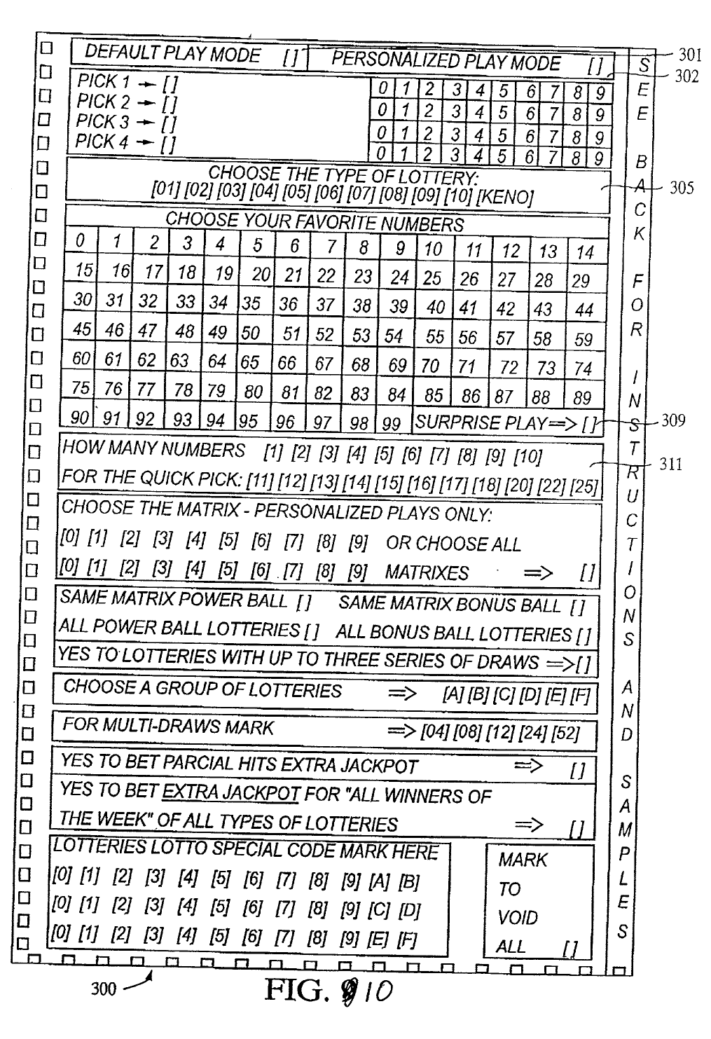

FIG. 10 illustrates an alternative play slip 300 that may be used for any configuration of the world Lotteries Lotto. The play slip 300 includes several features that allow a player to customize lottery play. A default play mode section 301 and a personalized play mode section 303 may be used to chose a mode of play. The default and personalized play modes 301 and 303 incorporate the same features as described with respect to FIG. 9.

A lottery type section 305 allows the player to choose the type of Lottery to play against. For example, the player could mark the [06] in the section 305 to indicate a pick 6 lottery. The play would then be compared to draws of all participating pick 6 Lotteries world wide. The player could also mark the [KENO] in the section 305 to indicate a Keno game.

When Keno is selected, the player may be required to match a specific quantity of numbers from all numbers drawn by the local lottery. For example, a local lottery may draw eleven numbers and require that a player match seven of the eleven drawn numbers in order to win. A player using the play slip 300 might similarly be required to match seven numbers in order to win at the world lotteries lotto. The seven numbers may be chosen manually using the play slip 300. Alternatively, by filling in a surprise section 309, a computer may choose eleven numbers at random. The player may mark a number in a quick pick section 311 to select a specified number of random numbers for the computer to select.

The play slips 300 includes a 100 number matrix (numbers 0-99) section 307 that allows a player to choose numbers manually and a surprise section 309 that allows a computer to pick numbers based on the lottery type selected in section 305. The player may also mark a number in a pick section 311 to select a specified number of random numbers for the computer to select.

Other features of the play slip 300 correspond to similar features illustrated on the play slip 250 of FIG. 9, and described above.

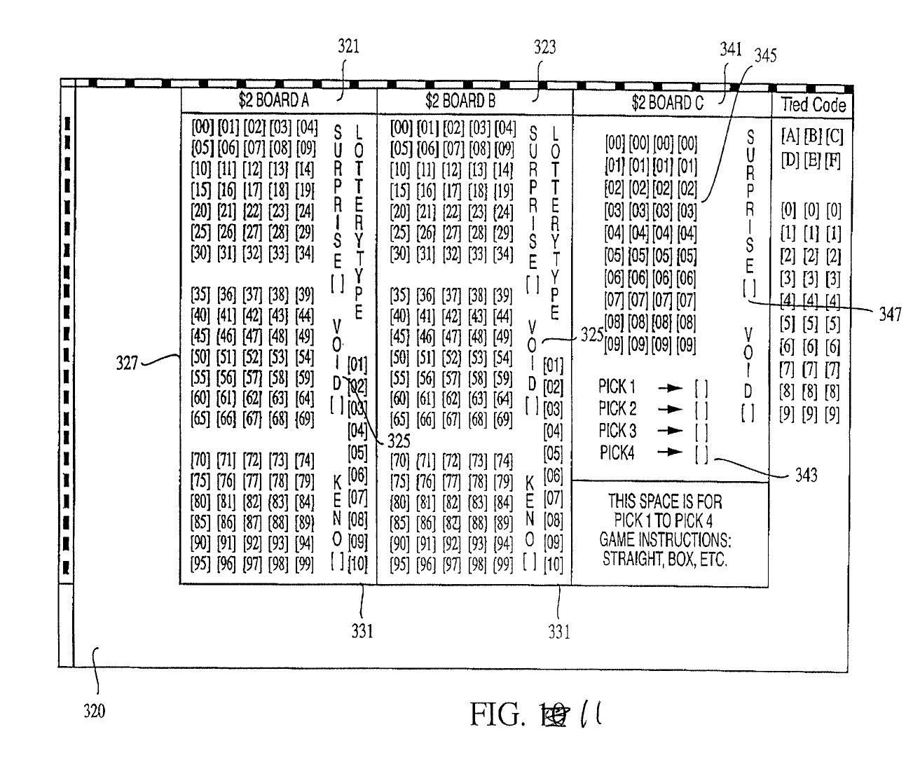

FIG. 11 illustrates yet another play slip 320 that may be used with the world lotteries lotto. The play slip 320 is similar to the play slip 200 shown in FIG. 7A. However, the play slip 320 includes additional features. The play slip 320 includes the boards 321 and 323. The boards 321 and 323 may be used to make two plays using the matrices 327. The matrices 327 include 100 numbers (numbers 00 to 99). The boards 321 and 323 each also include a lottery type section 331. The lottery type section 331 may be used to select a lottery type ([01] to [10] or [KENO]). Using the boards 321 and 323, a player may select a lottery type and specify numbers to play for one or two plays. The player may also use a surprise feature 333 that allows a computer to select numbers occurring to the lottery type chosen using the lottery type section 331. Finally, the boards 321 and 323 include a void block 325. When marked, the void block 325 prevents a play from its associated board (321 or 323).

The play slip 320 also includes a pick board 341 that allows a player to choose pick 1, pick 2, pick 3 or pick 4 using a pick section 343. Associated with each of the selections in the pick section 343 is a ten number matrix section 345. Thus, if a player selects pick 2, the player would select one number from each of two matrices in the matrix section 345. Alternatively, the player may select surprise 347 to have a computer select numbers randomly according to the pick number chosen in the pick section 343.

Other features of the play slip 320 are similar to those of the play slip 200 illustrated in FIG. 7A and described above.

The plays described above and illustrated in the figures are by way of example. Other play slips may be designed that would fall within the spirit of these illustrated examples. For example, a play slip may include more than three play boards. Another play slip may include different types of boards (straight lottery, Power Ball®, quick pick).

As stated above, funding of the lotto 100 may be based on increased local lottery sales, or by charging each player of the lotto 100 a fixed or variable fee. Other finding options are possible. For example, an organization separate from a government lottery agency may be allowed to sell world lottery lotto tickets to players, returning all or a portion of any wager amount to the jurisdiction's lottery agency. In return, and to generate income, the organization may provide advertising space that can be used to target advertising to world lotteries lotto players. Income generated by such advertisements may be enough to show a profit for the organization. In another embodiment, the organization pays a fee or royalty to the lottery agency in order to sell the world lotteries lotto. Advertising revenue would then offset the cost of this royalty payment. This funding mechanism may be adapted for use with online world lotteries lotto ticket sale, such as ticket sales over the Internet (where permitted).

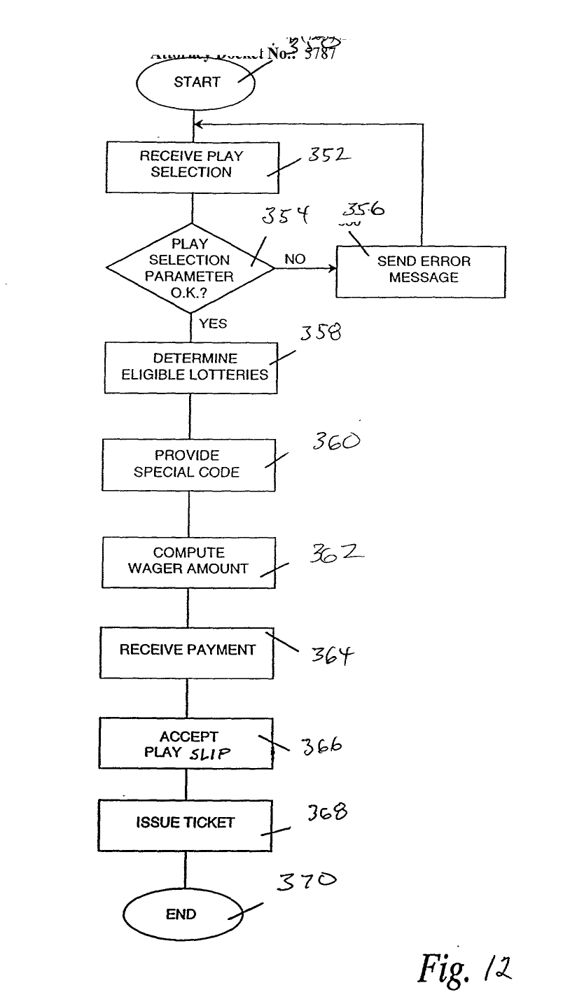

Operation of the lotto 100 may be under control of a local or remote system or site, such as the site 101 shown in FIG. 2B. All wagering computations, play and draw comparisons, data gathering from other lotteries, and acceptance of a play may be controlled by the computer 102, or by one or more distributed processors, including processors at the inputs 106, 106′ and 106″. The processors and the computer 102 may operate according to one or more routines and may employ one or more algorithms. FIG. 12 is a flowchart illustrating certain processes executed on the processors and the computer 102 during an operation of the lotto 100. The flowchart assumes the lotto 100 is played as a lottery coupled to one or more local lotteries. The process starts with block 350.

In receive play selection block 352, an input device, such as the input 106 shown in FIG. 2B, receives a lotto 100 play slip, marked to indicate a players play, and any special features. An example of the play slip is shown in FIG. 9. In parameter verification block 354, the computer 102 determines if the player's selections satisfy certain criteria. For example, if the player designates a pick 6 lottery, the computer 102 will verify that at least six numbers are marked in the matrix section. Other special conditions and features will be checked in accordance with the descriptions provided above for the play slip 250 of FIG. 9, and other components of the world lotteries lotto. If the play slip contains an error such that processing cannot be completed, the computer 102 will generate an error message, block 356, that may be displayed at the input 106. The computer 102 will then await a subsequent submission of the play slip.

If the parameter check indicates no errors, the computer 102 optionally determines the eligible lotteries against which to enter the play, block 358. For example, the computer may determine that the play may be compared to draws of all bonus ball lotteries. As part of this optional step, the computer 102 may, also optionally, store the play in the database 104 until the appropriate draws are complete. In an optional routine, the computer 102 may identify the play by the special code generated in the next processing step, block 360. The special code may be marked on the play slip by the input 106, or may be subsequently marked on the play slip by the player. In either event, the special code may be used to tie the lotto 100 to the play of a local lottery.

The computer 102 next determines a required wager amount, block 362, if appropriate, and provides an indication of the amount to the player using the input 106. In receive payment block 364, the computer 102 receives an indication that payment of the wager amount is complete. Such payment may be by way of credit card, electronic check, or a manual indication, such as a keystroke, of a lotto 100 employee.

In accept play slip block 366, the computer accepts the play. The input 106 may return the play slip to the player to enter the special code. Optionally, the special code may be entered by the computer 102. If the play slip has been returned to the player, the computer 102 waits for an indication that the play slip has been re-entered into the lotto 100 system. In issue ticket block 368, the computer 102, in conjunction with the input 106, issues a ticket to the player. The ticket includes information related to plays (i.e., the numbers chosen) and the special code. The process then ends, block 370.

As an alternative to the lotto 100, the world lotteries lotto concept may be extended to an Internet game. In this embodiment, the world lotteries lotto may be played in jurisdictions that allow Internet wagering. The world lotteries lotto of this embodiment may also be coupled to one or more local lotteries.

When played as an Internet game, the lotto 100 may use the same general and specific rules, described above, for the non-Internet version. Additional rules may be added to prevent unauthorized play over the Internet, such as play by persons under a specific age. For example, to use the Internet to play the lotto 100, a players may first have to register for, and receive, a password. The Internet version of the lotto 100 may then be accessible only to those players who correctly enter a password.

Use of the Internet may facilitate payment of any required wager amount for playing the lotto 100. For example, the lotto 100 may include direct debit of a player's bank account. Direct debit payment may also be incorporated into other embodiments of the world lotteries lotto.

As an alternative Internet lottery game, the lotto 100 may provide a wager-free option in which players access a lotto 100 website and make plays in which no wager is required. In an embodiment, the player whose numbers match those of a draw may be awarded points. When enough points are accumulated, the player may trade the points in for a prize or for merchandise. In another embodiment, the player may pay a small fee, for example an annual fee of $25. Upon paying the fee, the player is eligible to make plays. If the player then matches a draw, the player wins a prize, which may be a cash prize.

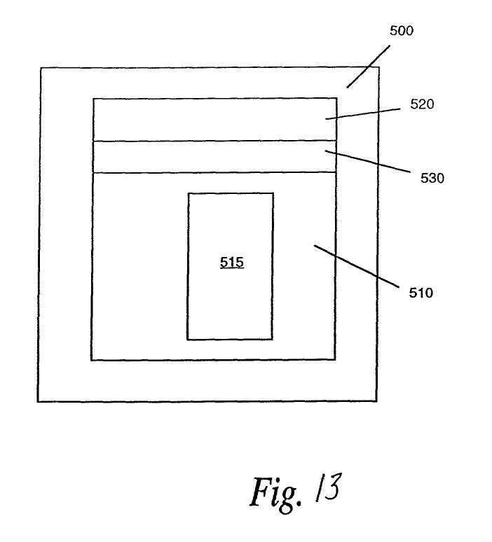

A graphical user interface (GUI) may be used to facilitate play of the lotto 100, including the Internet version of the lotto 100. An example GUI 500 is shown in FIG. 13. The GUI 500 may be displayed on any display capable of displaying digital or analog data, including the inputs 106, 106′ and 106″ shown in FIG. 2B; personal computer, such as a personal computer in a player's home; a television (not shown); and a mobile data device (not shown), such as a cellular phone and a personal data device, for example.

The GUI 500 includes a main display section 510 that presents an electronic representation 515 of the lotto 100 play slip. The play slip 515 may include all the sections as does the play slip 250 shown in FIG. 9. Sections of the play slip 515 corresponding to the play slip 250 may allow the player to enter data to complete the ply slip. Data entry may be by key stroke, point and click, and voice recognition, for example. A pull down menu bar 520 allows the user to select features of the lotto 100, such as a list of lottery types, jurisdictions where these lottery types are played, a set of rules, and a function that computes odds of winning the lotto 100, for example. A tool bar 530 may be optionally displayed. The tool bar includes icons for frequent operations associated with playing the lotto 100, including, for example, a printer icon to print a lottery ticket, and a submit icon.

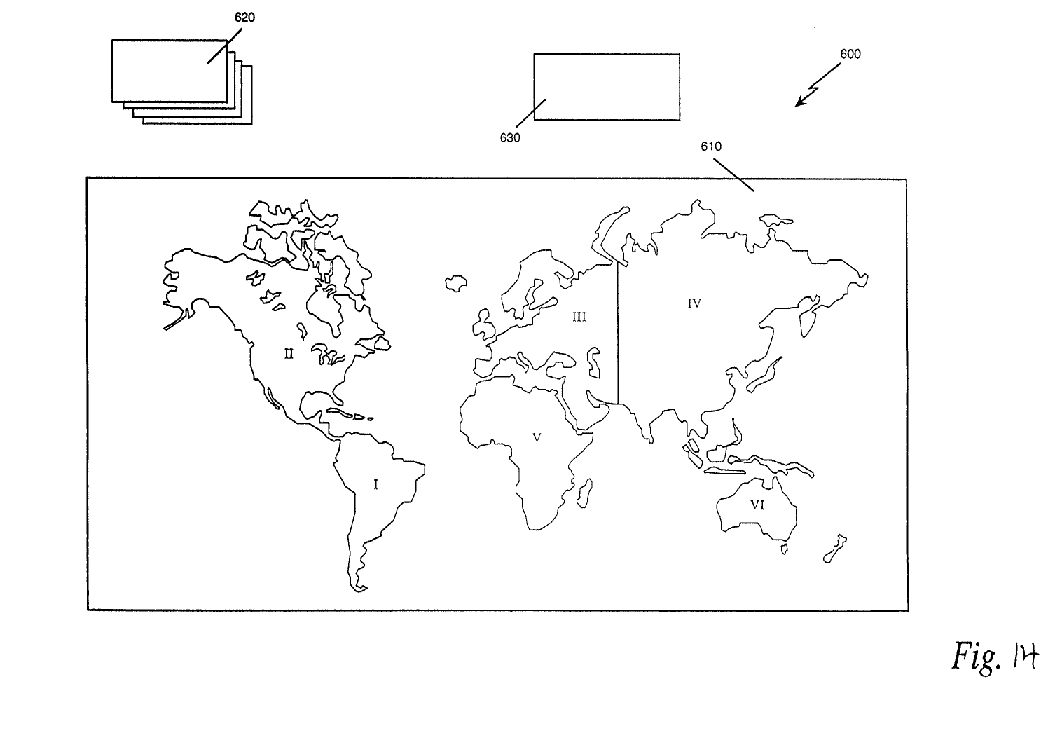

As yet another alternative, the world lotteries lotto concept may be expressed in a board game. FIG. 14 is an example of a board game 600 incorporating the lotto 100 design. The board game 600 includes a map section 610 displaying the world in Mercator projection format. Six continents are labeled with numerals I through VI. Each such continent will have an associated number of local lotteries of various types. The object of the game may be to amass the largest total prize or to win a single largest jackpot by playing any of the local lotteries in conjunction with the world lotteries lotto. For example, a player may combine the value of any consolation prizes with any jackpot wins to compute the players total earnings. Players may move between continents in any fashion, but the game may restrict occupancy of any one continent to one player at a time. When six players play, this implies that when one player is able to move to a continent, another player must leave. The game may allow players to play local lotteries in their current continent, and to play the world lotteries lotto in other continents. The players may be limited to playing the world lotteries lotto only on the basis of their own local lottery types. For example, a player in North America may play a 6/49 local lotteries, an then would be eligible to play the world lotteries lotto against all other 6/N lotteries world wide.

The board game 600 may include a card set 620 that requires players to skip turns, move to other continents, and take other actions that add interest and chance to the game. Players may select a card on every play, or at random intervals. Information needed to play the game may be displayed in an information block 630. Such information may include a list of local lottery types, for example.

To make the game challenging, a player may be given an amount of play money at the start of the game. Each play of a local lottery and the world lotteries lotto requires payment of a portion of the play money. Likewise, movement between continents may require payment of play money. Initial assignment to continents may be determined by a roll of a die.

The world lotteries lotto, or other games, may be played as a computer game or a television game. The world lotteries lotto may also be played using a computer network such as the Internet.

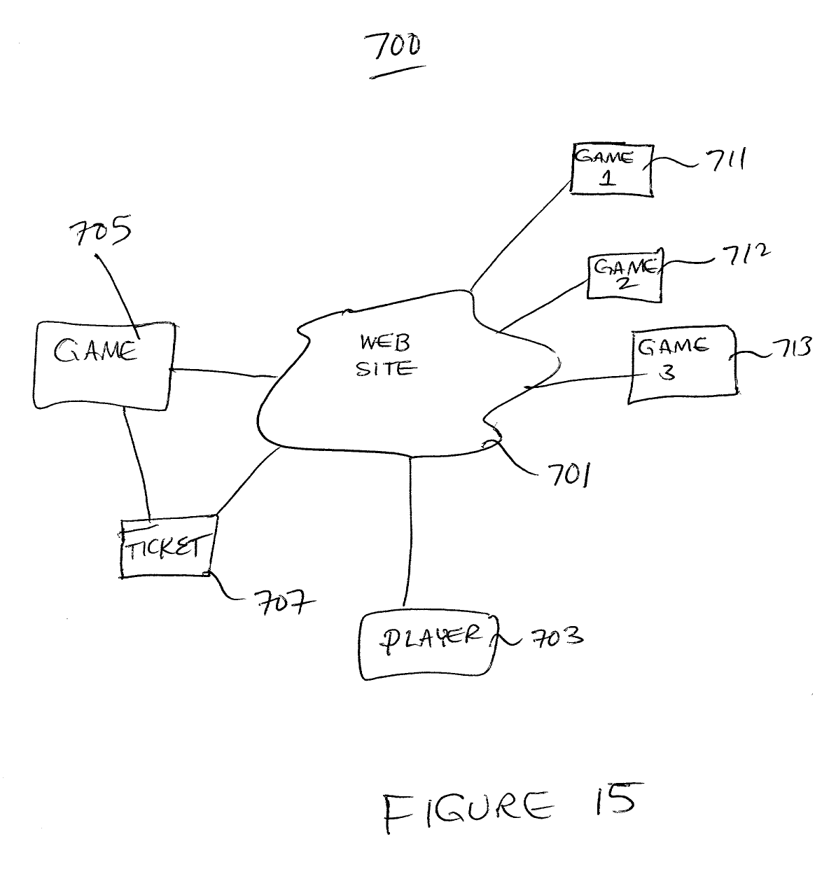

FIG. 15 illustrates another embodiment of a game. A game system 700 may be implemented as a casino game, a lottery game, an Internet game, or any other game, including popular board games. In the illustrated embodiment, the game system 700 is implemented as an Internet-based game. However, similar principles may be used to adapt the game system 700 to any of the above-mentioned game types.

The game system 700 uses an Internet Web site 701 to connect a player terminal 703 to a game 705. Using the Web site 701, a player at the player terminal 703 may purchase a ticket 707 to play the game 705. Also shown coupled to the Web site 701 are games 711-713. Although the illustrated embodiment shows four games (i.e., the game 705 and the games 711-713), the game system 700 may be used to couple any number of games.

The game 705 and the games 711-713 may be associated with a single lottery authority, or each of the four games may be associated with lotteries from different authorities or jurisdictions. The game 705 and the games 711-713 may all be of a similar type (e.g., 7/99), or may comprise different lottery types.

The player terminal 703 may be a personal computer, a portable computer, a personal data assistant (PDA), a Web-enabled cellular or mobile telephone, or any other device that is capable of connecting to the Web site 701 and displaying data from the Web site 701. The player terminal 703 may also be implemented as a kiosk at, for example, a convenience store. Finally, the player terminal 703 may be implemented in current lottery systems, wherein the player terminal 703 would be operated by an individual other than the player.

The game 705 may be a lottery-type game in which the player chooses a number from a set number matrix according to a rule set. For example, the game may be a pick six lottery in which the player chooses six numbers from a matrix of 100 numbers (0 to 99). The game system 700 allows the player to play the game 705, including buying tickets (chances), selecting numbers, and receiving results of a play, using only the player terminal 703.

The game ticket 707 may be implemented as an electronic ticket or a paper ticket, or both. When the player terminal 703 comprises a personal computer, for example, the game ticket 707 may be displayed at the player terminal 707, may be stored electronically at a storage (not shown) of the player terminal 707, and may be printed, or otherwise rendered into a hard-copy format. The game ticket 707 may be similar to the play slip 300 shown in FIG. 10.

To ensure security of an Internet-based transaction, the game ticket 707 may be provided to the player terminal 703 after verification of an identity of the player requesting the play. Such verification may be implemented by using a digital signature, for example. Use of digital signatures is well-known in the art, and need not be described herein.

The player may pay for a play of the game 705 by using a credit card account. In another embodiment, the Web site may be authorized by the player to debit a bank account of the player. Alternatively, the player may pay an up-front amount to establish an account with the game system 700, and may make plays as long as the account balance is positive.

The game 705 may be a lottery game, such as a state-sponsored lottery game, for example. Players who play the game 705 remit funds to the Web site 701 to pay for plays. A portion of the remitted money may be retained by an operator of the Web site 701, and the remaining money forwarded to an activity (e.g., the state lottery authority) that sponsors the lottery. In an alternative embodiment, all remitted money from the player is forwarded to the lottery sponsor, and the Web site generates revenue through Web-site advertising.

The game system 700 may provide a regular customer feature in which players who make frequent plays are accorded special privileges. The privileges may include reduced price tickets, special prizes, points that may be used to purchase items from an online catalog, or from another merchant, and an opportunity to participate in second-chance draws. The consolation draws of the game system 700 may be based on numbers drawn in other lotteries that are associated with the game system 700. For example, the consolation draws may be based on draws of any one or more of the games 711-713. In operation, the consolation draws of the game system 700 may function in a manner similar to that of the world lotteries lotto system 70 shown in FIG. 2A. In particular, the player who plays the game 705 may automatically be entered into a consolation game that compares the number played in the game 705 to numbers drawn in one or more of the games 711-713. Should the numbers played in the game 705 match exactly the numbers drawn in any of the games 711-713, the player wins a consolation prize. In an alternative embodiment, the player may win a smaller consolation prize should some portion of the numbers played (e.g., 5 out of 7 for a 7/99 lottery) match the draws of the games 711-713.

In an embodiment, only a most recent number selection by the player is used to compare the selected numbers to the draws of the lotteries 711-713 for purposes of awarding the consolation prize. Alternatively, all previously played numbers, or a selected set of the previously played numbers may be used in awarding the consolation prize. Whether more than the most recently-played number is used for the consolation prize may be based on the player's status as a regular player. That is, if the player plays all instances of the game 705, the player may be considered a regular player and may be eligible for the consolation prize using all previously played numbers, or a set of the recently played numbers. Alternatively, the player may be considered a regular player if the player plays a minimum number of instances of the game 705, such as one out of three instances, for example. In yet another embodiment, the player may be considered a regular player if the player places a minimum number of “bets,” or makes a minimum number of plays for any one instance of the game 705. In yet another embodiment of the game system 700, a regular player may be eligible for an enhanced consolation prize, while a non-regular player may be eligible for a smaller consolation prize. In these described embodiments, the game 700 is designed to reward more frequent plays of the game 705.

The player, using the player terminal 703, may receive automatic notification of any winnings from playing the game 705, or from participating in the consolation draws of the game system 700. For example, when the player plays the game 705, should the player win a main prize of the game 705, the player may be presented with an electronic notification of such winning. The electronic notification may be by way of an e-mail sent to the player terminal 703, for example. Other mechanisms for notification may include notifying the player of the winning when the player next connects to the Web site 701. Similar mechanisms may be used to notify the player of any wins within the consolation system of the game system 700. Alternatively, the player may be notified by an automatic, or computer-generated telephone call to the player's telephone, or by way of a mailing to the player's residence.

The terms and descriptions used herein are set forth by way of illustration only and are not meant as limitations. Those skilled in the art will recognize that many variations are possible within the spirit and scope of the invention as defined in the following claims, and there equivalents, in which all terms are to be understood in their broadest possible sense unless otherwise indicated.

In the claims:

1. A lottery game, comprising:
a play selector mechanism used for making a play of the lottery game, the selector mechanism comprising a module for selecting the play of the lottery game according to one or more features; and
a comparator that compares the play of the lottery game to a draw of a first lottery, wherein one or more of the one or more features correspond to like features of a second lottery.

2. The lottery game of claim 1, wherein the first lottery is from a first jurisdiction and the second lottery is from a second jurisdiction different from the first jurisdiction.

3. The lottery game of claim 1, wherein the lottery game is coupled to the second lottery, and wherein the play of the lottery game is preceded by a play of the second lottery.

4. The lottery game of claim 1, wherein one of the one or more features comprises a lottery type and a maximum size of a numbers matrix.

5. The lottery game of claim 4, wherein the lottery type comprises pick N, where N is an integer from 1 to 4, and Keno.

6. The lottery game of claim 1, wherein the lottery game is accessible from a remote site via the Internet.

7. The lottery game of claim 1, wherein the lottery game assigns regular player status to a player based on the number of times the player plays the lottery game.

8. A method of playing a lottery game, comprising:
receiving a play of the lottery game; and
comparing the play to a draw of a local lottery.

9. The method of claim 8, further comprising:
verifying parameters of the play against a rule set;
generating an error message if a parameter conflicts with a rule of the rule set;
determining one or more eligible local lotteries for use in comparing the play to draws of the one or more eligible local lotteries;
providing a special code linking the lottery game to one or more of the one or more eligible local lotteries;
computing a required wager amount;
receiving the required wager amount;
issuing a lottery game ticket, wherein the lottery game ticket includes the special code and one or more plays; determining a type of lottery for the local lottery; and
restricting a play of the new lottery to a play of a type of lottery for the local lottery.

10. The method of claim 9, wherein the type of lottery comprises pick N, where N is an integer between 1 and 4, and Keno.

11. The method claim 8, further comprising:
assigning regular player status to a player who has made at least a minimum number of plays of the lottery game.

12. The method of claim 8, wherein the step of receiving the play of the lottery game comprises:
receiving the play of the lottery game via an Internet web site.

13. The method of claim 12, further comprising:
receiving payment from players via the Internet web site.

14. The method of claim 12, comprising:
notifying a winner of the lottery game via electronic mail.

15. A method for playing a lottery, comprising:
playing a first local lottery, wherein the first local lottery is a lottery of a first type; and
playing the lottery, comprising:
making a play of the lottery based on the first type,
comparing the play of the lottery to one or more draws of second local lotteries of the first type, and
awarding a prize when the comparison indicates a match between the play of the lottery and at least one of the one or more draws of the second local lotteries.

16. The method of claim 15, wherein the play of the lottery is chosen from a numbers matrix of 0 to 99.

17. The method of claim 15, wherein the one or more draws of the second local lotteries are chosen from any numbers matrix up to and including the numbers matrix of 0 to 99.

18. A worldwide lottery game method, comprising:
making a play in a first lottery game in a first jurisdiction according to a first lottery type;
making a play in the worldwide lottery game in the first jurisdiction;
comparing the play of the worldwide lottery game to a draw of one or more second lotteries, each of the one or more second lotteries in a jurisdiction other than the first jurisdiction; and
awarding a prize when a match exists between one of the one or more second lotteries, wherein the worldwide lottery is a lottery according to the first lottery type, and wherein each of the one or more second lotteries is a lottery of the first lottery type.

19. The method of claim 18, wherein the first lottery type is a pick N lottery, where N is an integer between 1 and 4, inclusive.

20. The method of claim 19, wherein the first lottery type is a Keno game.

21. The method of claim 19, further comprising providing a numbers matrix of M for the worldwide lottery, wherein M is an integer between 0 and 99, inclusive.

22. The method of claim 18, further comprising:
providing a code based on the first lottery game; and
using the code with the play of the worldwide lottery, wherein the code ties the play of the worldwide lottery to the play of the first lottery game.

23. The method of claim 18, further comprising determining a wager price for the play of the worldwide lottery.

24. The method of claim 23, wherein the wager price is based on the type of the worldwide lottery.

25. The method of claim 18, wherein the first lottery is a pick r+bonus lottery, wherein r is an integer between 1 and 10 exclusive, and the bonus is a set of q numbers, where q is an integer between 1 and 10 inclusive, and wherein the first lottery draws q bonus numbers, and further comprising:
picking a set of r numbers for the play of the play of the first lottery game.

26. The method of claim 25, further comprising:
picking a same set of r numbers for the worldwide lottery, wherein the match of the play of the worldwide lottery and the draw of the one of the one or more second lotteries is based on a match of subset comprising the set of r numbers and the q bonus numbers and a corresponding quantity of r numbers in the draw of the one of the one or more second lotteries.

27. The method of claim 18, further comprising:
picking a set of n numbers for the play of the play of the first lottery game; and
picking the same set of n numbers for the worldwide lottery, wherein the match of the play of the worldwide lottery and the draw of the one of the one or more second lotteries is based on an exact match of the set of n numbers and corresponding numbers in the draw of the one of the one or more second lotteries.

28. The method claim 18, further comprising:
assigning regular player status to a player who has made at least a minimum number of plays of the lottery game.

29. The method of claim 18, wherein the step of making a play in the worldwide lottery game comprises:
submitting the play to an Internet web site.

30. The method of claim 29, further comprising:
submitting a payment via the Internet web site.
